(19) United States
(12) Patent Application Publication
(10) Pub. No.: US 2005/0225076 A1
(43) Pub. Date: Oct. 13, 2005

(54) System, method and apparatus for coupon processing and booklet

(76) Inventors: James B. McCreary, Stamford, CT (US); Merritt W. Dixon III, Savannah, GA (US)

Correspondence Address: FROMMER LAWRENCE & HAUG, 745 FIFTH AVENUE- 10TH FL., NEW YORK, NY, 10151, US

(21) Appl. No.: 11/036,248

(22) Filed: May 4, 2005

Related U.S. Application Data
(63) Continuation-in-part of application No. 10/937,829, filed on Sep. 9, 2004.
Application No. 10/937,829 is a continuation of application No. 10/620,050, filed on Jul. 15, 2003, now abandoned.
Application No. 10/620,050 is a continuation of application No. 10/236,673, filed on Sep. 6, 2002, now abandoned.
Application No. 10/236,673 is a continuation of application No. 09/976,234, filed on Oct. 12, 2001, now abandoned.
Application No. 09/976,234 is a continuation of application No. 09/314,583, filed on May 18, 1999, now Pat. No. 6,697,785.
(60) Provisional application No. 60/086,045, filed on May 19, 1998.

(51) Int. Cl. G09F 1/00

(52) U.S. Cl. 283/56

(57) ABSTRACT

A coupon booklet for use by a customer at a number of stores. The booklet may include a front cover and a back cover, a number of pages provided between the front and back covers, a listing of a plurality of items entitled to discounts provided on at least one of the front and back covers and the number of pages, and a number of transmitting devices each coupled to one of the front and back covers and the number of pages and operable to transmit an information signal relatable to the plurality of items in a wireless manner. The front and back covers and the number of pages may be arranged such that the front and back cover and the number of pages are openable and closeable in a book-like manner.

This application is a continuation in part of copending application Ser. No. 10/937,829 filed Sep. 9, 2004 now abandoned, which is a continuation of application Ser. No. 10/620,050 filed Jul. 15, 2003, which is a continuation of application Ser. No. 10/236,673 filed Sep. 6, 2002 now abandoned, which is a continuation of application Ser. No. 09/976,234 filed Oct. 12, 2001 now abandoned, which is a continuation of application Ser. No. 09/314,583 filed May 18, 1999 now U.S. Pat. No. 6,328,339, which claims the benefit of provisional application 60/086,045 filed May 19, 1998, all of which are incorporated herein by reference.

### BACKGROUND OF THE INVENTION

The present invention relates to a system, method and apparatus for processing coupons and more particularly to a system, method and apparatus for facilitating the verification and settlement of coupons. The present invention relates to a booklet and a system therefor for processing information relating to discounts of items listed therein.

Coupons are used by a large number of people to obtain discounts on a variety of products, such as food items. Such coupons may be presented to a retailer by a customer at the time of sale. The retailer may send the coupons to a clearinghouse, which is operated by a clearinghouse corporation where valid coupons are identified. The valid coupons are sent to the manufacturer who redeems the retailer for the discount.

Retailers are typically short-changed by accepting coupons. To explain, retailers essentially lose money on each discounted item and count on being redeemed. Unfortunately, the clearinghouse all too often mishandles the coupons which leaves the retailers unreimbursed. When it is considered that retailers accept volumes of coupons each week, it will be immediately recognized that lost income due to coupon-mishandling costs the retail industry huge sums each year.

Manufacturers often lose money when, for example, the cashier or the store submits more coupons than entitled. Sometimes this is done intentionally in order to defraud the manufacturer. Worse, by the time the manufacturer discovers the fraud the culprit has long absconded.

Consumers find coupons to be more hassle than their worth. Detached or detachable coupons are unkempt and clutters one's pockets or pocket book. Moreover, coupons are unorganized and it is difficult to find the desired coupon when needed such as when checking out. The disorganized nature of coupons also makes it difficult to keep track of valid coupons such as coupons which have not expired.

What is needed is a system which facilitates the verification and settlement of coupons.

### OBJECTS AND SUMMARY OF THE INVENTION

An object of the present invention is to provide a technique which facilitates processing of coupons for a plurality of stores.

Another object of the present invention is to provide a coupon manager system operable for use with a plurality of stores and having a central processor and a number of front ends and a back end apparatus for each store.

Another object of the present invention is to provide a coupon manager system as aforesaid wherein the central processor provides an information useable for auditing purposes.

Another object of the present invention is to provide a booklet having a plurality of items with information identifiable with a single bar code.

Another object of the present invention is to provide a system for processing the booklet.

Another object of the present invention is to provide a number of transmitting devices located on the booklet and usable with a system for transmitting information signals related to the booklet.

In accordance with the foregoing objects, there is provided a coupon manager system for processing coupons in a predetermined manner. The predetermined manner in at least one embodiment determines a redemption value of the coupons. In one aspect of the present invention, the coupon manager system includes a front end cash register at the point of sale, a back end for processing the coupons received and a central processing computer for receiving and collating the processed coupon information. The central processing computer may collate the coupon information from a plurality of retail stores and send reports to manufacturers. The central processing computer may function as an auditing system which maintains account balances of redemption values owed and paid.

The back end which may be operated independently as an apparatus includes in at least one embodiment an image scanner for imaging the coupons. A central processing unit determines the validity of the coupons based on matching coupons with transactions and/or manufacturers. In one aspect of the present invention, the back end apparatus destroys the valid coupons. The back end apparatus may include one or more bins for receiving the processed coupons including a destruction bin for receiving the destroyed coupons, a non-participating bin for receiving coupons of manufacturers not participating in the coupon manager service, an exception bin for receiving coupons of an anomalous nature such as coupons which cannot be assigned to a transaction or manufacturer and a future bin reserved for future applications.

A booklet of the present invention includes front and back covers and pages. A listing is provided which lists the product discounts. A single bar code is provided for a plurality of items to be discounted. In at least one embodiment, the listing of the booklet is an index or a table-of-contents. The index may be organized according to any number of categories including the type of product, price and manufacturer. The booklet may be color coded for ease of access. In addition, the booklet may include additional information such as coupon advertisements, sweepstakes or cash prizes. The booklet may include any type of coupon, rebate or other form of redemption including a credit which is credited to a credit account. The booklet may be incorporated in an integrated system or utilized independent of the coupon manager system such as in a non-integrated system.

In another embodiment, a coupon booklet for use by a customer at a number of stores may be provided. The booklet may comprise a front cover and a back cover, a number of pages provided between the front and back covers, a listing of a plurality of items entitled to discounts provided on at least one of said front and back covers and said number of pages, and a number of transmitting devices, each coupled to one of said front and back covers and said number of pages and operable to transmit an information signal relatable to said plurality of items in a wireless manner, wherein said front and back covers and said number of pages are arranged such that said front and back cover and said number of pages are openable and closeable in a book-like manner.

Other objects, features and advantages according to the present invention will become apparent from the following detailed description of the illustrated embodiments when read in conjunction with the accompanying drawings in which corresponding components are identified by the same reference numerals.

### BRIEF DESCRIPTION OF THE DRAWINGS

FIG. 1 is a diagram of the coupon manager system according to an embodiment of the present invention;

FIGS. 2A and B are diagrams to which reference will be made in explaining drawings of the coupon manager system of FIG. 1;

FIGS. 3A-3I are diagrams to which reference will be made in explaining drawings of the coupon manager system of FIG. 1;

FIGS. 4A-4C are diagrams to which reference will be made in explaining drawings of the coupon manager system of FIG. 1;

FIGS. 5A and B are diagrams of the system for processing the booklet of the present invention;

FIGS. 6A-6F illustrate an example of the booklet of the present invention;

FIGS. 7A-7G illustrate an example of the booklet of the present invention;

FIGS. 8A-8B illustrate an example of the booklet of the present invention;

FIG. 9 is a diagram of the system for transmitting and receiving information signals related to the booklet; and

FIG. 10 is a diagram of another arrangement utilizing the booklet according to another embodiment of the present invention.

### DETAILED DESCRIPTION OF THE PREFERRED EMBODIMENTS

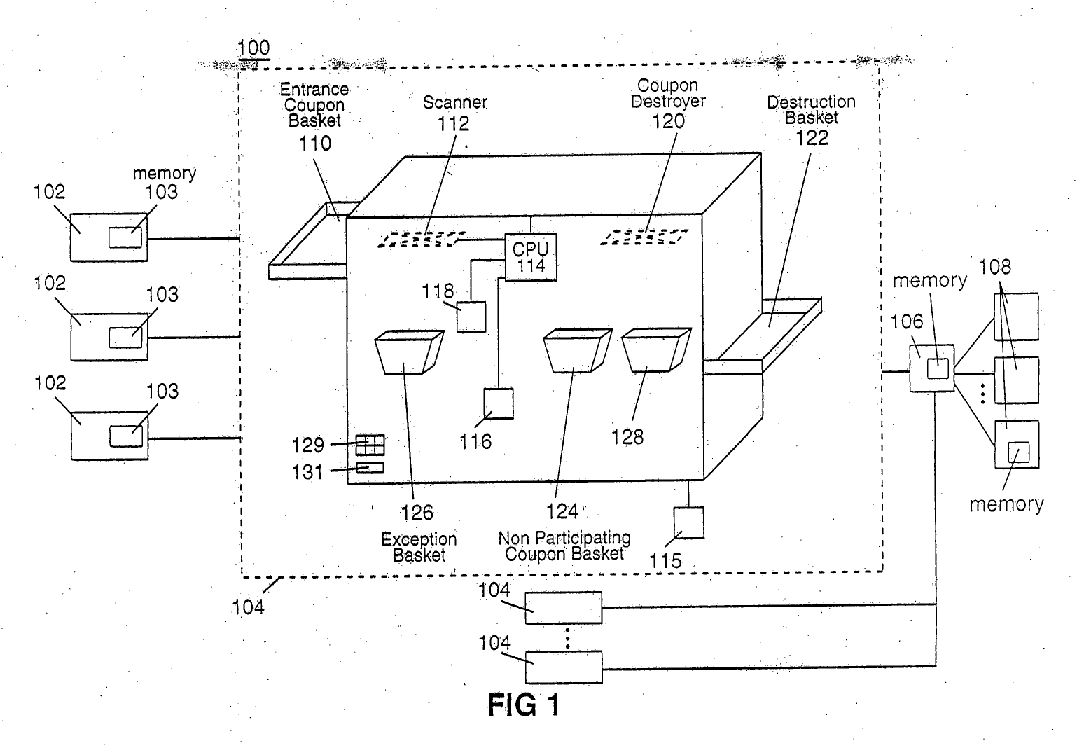

The coupon manager system 100 shown in FIG. 1 includes a front end 102, a back end 104 and a central processor 106 for processing coupons. The front end 102 receives coupons in exchange for goods purchased at a discount. The back end apparatus 104 processes the coupons in a predetermined manner. The central processor 106 receives the processing information relating to the coupons from a number of back end units located at a number of stores. The central processor 106 collates the information and forwards the same either electronically or otherwise to the appropriate manufacturer(s) 108. Thus, the present invention advantageously replaces the clearinghouse with a coupon manager system which facilitates the verification and settlement of coupons.

The front end 102 may be situated at the point of sale of a retail store which comprises a number of cash registers each operated by a cashier. Each cash register may include a bar code reader 103 such as an in-lane scanner which uses an optical system such as a laser for reading bar codes which may be located on the coupons. The bar code scanner may scan universal product codes, coupon prefixes (5 or 99), company codes, family codes, value codes and/or check digit codes. The cashier operates the bar code scanner by scanning the bar code on the coupon. The transaction is electronically recorded by the cash register and forwarded thereby to the back end apparatus 104. Data of the bar code may be forwarded to the back end apparatus. In addition, the cashier may enter an override on a keypad which inputs transactional information of a discount relating to a coupon which cannot be read by the bar code scanner. Other information such as the cashier identification which identifies the cashier may be entered at the cash register and forwarded to the back end apparatus for processing with the coupons.

The back end apparatus 104 receives the coupons at an input 110 which may be a hopper or receptacle for receiving the coupons. The hopper may shuffle the coupons by mechanical, vibration or air operation by the use of air jets, suction cups and so forth to a scanner 112.

The scanner 112 which may be controlled by the central processing unit 114 (CPU) scans each coupon received from the input 110 so as to obtain an image of one or both sides of the coupon. In at least one embodiment, the scanner obtains an image by, for example, use of photo-optics. The scanner 112 may be a grey scale scanner which encodes the colors of the coupon using either shades of grey or numerical codes. The scanner 112 is preferably a digital type scanner which obtains digital signals. Alternatively, an analog type scanner may be utilized. In at least one embodiment, the central processing unit 114 digitally pre-processes the digital image of the coupon by removing imperfections therefrom by use of imaging techniques. Such digital processing may significantly improve the accuracy of detecting the bar code as compared to the in-lane reader. It will be immediately appreciated that the improved accuracy advantageously reduces the number of coupons erroneously rejected due to a misreading of the coupon.

All or a portion of the digital image of the coupon may be stored in a memory 116 of the back-end apparatus 104. The central processing unit 114 may store in the memory 116 or any other suitable recording medium the coupon images for a predetermined amount of time such as 90 or 180 days for purposes of maintaining a record of the image. Advantageously, manufacturers will appreciate that the image records provide a paperless confirmation of the redemption process which may be used as an integrity check to reassure the manufacturer.

A coupon may have a universal product code (UPC) or an expanded bar code. The universal product code (UPC) may be sufficient for identifying products and prices or discounts. However, the UPC may provide little, if any, additional information some of which may be useful as marketing data. On the other hand, the expanded bar code may provide information for identifying the product and its price or discount and may also provide additional information such as a company code, a family code, a value code, a check digit code and other information useful as marketing data. Until now, retailers and manufacturers were content with UPC mainly because the UPC is the universally-accepted standard. In addition, the excessive cost of specialized scanners which read expanded bar codes has dissuaded retailers. The digitization of the bar code image as prescribed by the present invention allows the expanded bar code image to be analyzed digitally by the central processing unit 114 thereby obviating the need for specialized scanners.

The predetermined manner in which the central processing unit 114 processes the coupons may determine which coupons are redeemable by the manufacturer. In addition, or in the alternative, the predetermined manner processes the coupons to determine marketing information including, for example, information indicating the family or household from which the coupon is submitted or the name of the company or manufacturer. The information produced may be either a complete database of information or a summary of information relating to the coupons. The present invention may provide truncated information representing a subset of information such as a subset of stored images which is sent to the manufacturer as an integrity check representing the credibility of the summary information. The information produced may be coupled to the digital images of the coupons such that a combined database of information and related images is formed. The information may be printed by a local printer (not shown) or transferred either electronically or otherwise to the central processing system 106.

In determining which coupons are redeemable by the manufacturer, the central processing unit 114 validates each coupon. The central processing unit 114 may also determine whether the manufacturer is valid. Validity may be determined by matching the coupon as identified by the bar code to a transaction with reference to information stored, for example, in the memory 116 which may be preloaded from any suitable means including a recordable medium or downloaded automatically from sources such as the central processing system 106 or an on-line source such as the internet.

When the central processing unit 114 determines that a coupon is valid for redemption, the coupon is directed to a coupon destroyer 120 which destroys or physically alters the coupon to indicate that the coupon is not to be reused. The coupon destroyer 120 may destroy the coupons by spraying a liquid such as indelible ink or dye on the coupon, imparting a physical abrasion on the coupon or burning the coupon by directing a laser thereon. In at least one embodiment, the coupon is left substantially intact such that the coupon can later be identified after destruction for purposes of auditing. The coupon destroyer 120 may cut, shred or obliterate the coupon entirely. In addition, the coupon destroyer may be a spinning wheel(s) which may include a hub and spokes which perforate the coupon as the wheel(s) spins. The destroyed coupons are collected in a destruction bin or basket 122 whereby, in at least one embodiment, the destroyed coupons are arranged in an orderly manner and may be categorized according to product or manufacturer by means operated by the central processing unit 114. The destroyed coupons may be subsequently sent to the respective manufacturer with a report.

Coupons which are determined by the central processing unit 114 as originating from manufacturers who are not participants in the coupon manager system are directed to a non-participating coupon basket or bin 124. Coupons which have expired according to an expiration date may also be sent by the central processing unit 114 to the non-participating coupon basket 124. When the central processing unit 114 identifies an anomaly in processing a particular coupon, the anomalous coupon is directed to an exception basket or bin 126. The CPU 114 determines an anomaly, for example, when the number of coupons as counted by a counter 118 does not match the number of transactions for the coupons. A future applications basket or bin 128 is provided which is reserved for future applications such as for receiving those coupons which cannot be read either by the scanner 112 or the central processing unit 1 14.

The central processing unit 114 may detect local coupons which are redeemed by the retailer or a local company other than the manufacturer and directs the local coupons to, for example, the non-participating coupon basket 124. Hard to handle coupons such as “buy-one get-one-free up to a predetermined price” are directed by the central processing unit 114 to, for example, the future application's basket 128.

A keypad 129 may be provided for entering information such as the identification number of the operator or cashier. A display 131 may be provided for displaying the operations or information relating to the result of processing by the back end apparatus 104.

The central processing unit 114 may arbitrarily assign coupons to transactions conducted at the front end 102. For example, “n” number of coupons as counted by counter 118 may be matched arbitrarily with “m” number of transactions. In this manner, the actual transaction for a particular coupon is not necessarily matched with the associated coupon. For example, when a cashier overrides a transaction, there may be less coupons than transactions. In addition, a local printer 115 may be provided which prints information relating to the processing of the back end apparatus 104.

It will be appreciated that the present invention prevents fraud by quickly and accurately determining the redemption value of coupons. In addition, the central processing unit 114 may run a series of fraud security programs on the coupons processed. Such programs may include tabulating unlikely mixes of coupons, unlikely redemption rates by the cashier or the store and comparisons of coupon cuts to look for gang cuts. Suspicious results may be noted on the manufacturer's report.

Coupon information processed by the back end apparatus 104 of a number of retail stores is forwarded to the central processing system 106. The information may be transferred to the central processing system 106 at predetermined intervals such as nightly. The central processing system 106 processes the received information which may involve collating the information in a predetermined manner such as by manufacturer or type of goods so as to generate a report. The central processing system 106 may generate reports including special enhanced reports, multiple reports and/or the digital images. The report may be broken out by retailer's store. The reports may be available over a secured internet access or the like. The reports may further include information such as time of redemption, information contained in the coupon bar code and/or information indicating the product purchased with the coupon. The reports may include a summary/detailed report of all items processed for settlement. The reports may also indicate why a coupon or coupons were not processed, such as for failure of having a bar code, only having a partial bar code, hand-written coupon, expired coupon and so forth. The report may indicate the total redemption value. In addition, or in the alternative, the report may break down the coupon redemption by categories of goods and may provide an analysis of the scanned image of the coupon. The report may include grand totals as well as sub-totals. The reports may be supplied to any desired party including the manufacturer, retailer or service corporation.

It is within the scope of the present invention to provide a system which maintains account balances between retailers, manufacturers and a service corporation which operates the present invention based on the information processed by the central processor 106. For example, the central processing system 106 may arrange to electronically transfer funds between the manufacturers and the retailers in response to the coupon information result.

The present system may process several different forms of coupons including, for example, individual coupons in the form of a two-sided slip of paper, coupons coupled together or flyers. The present system may process information on more than one side of the coupon such as the bar code on one side and family information on the other side.

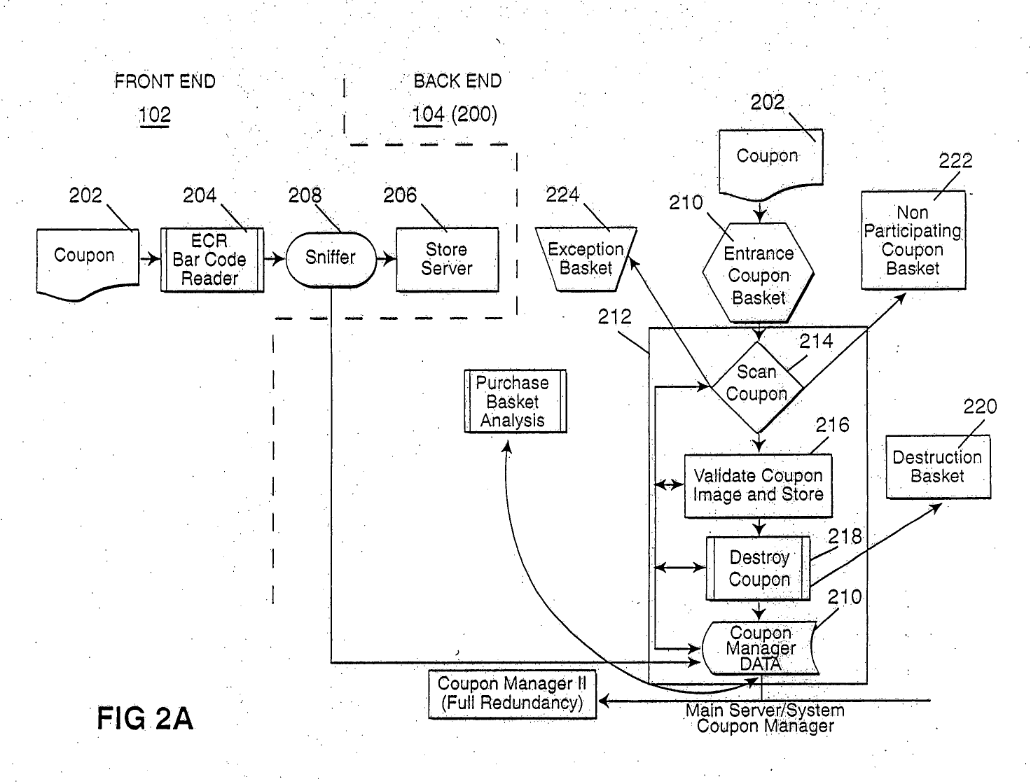

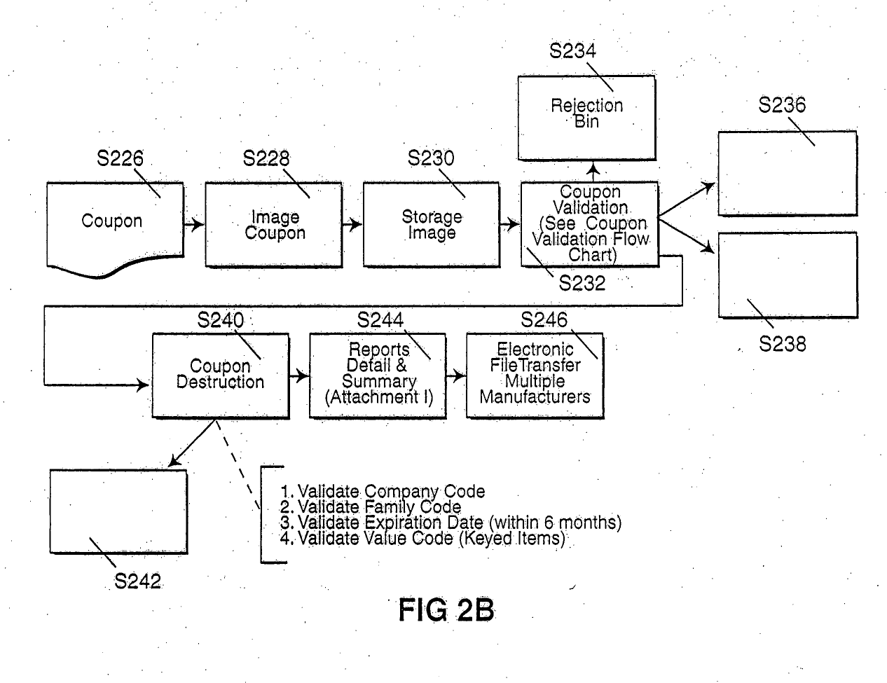

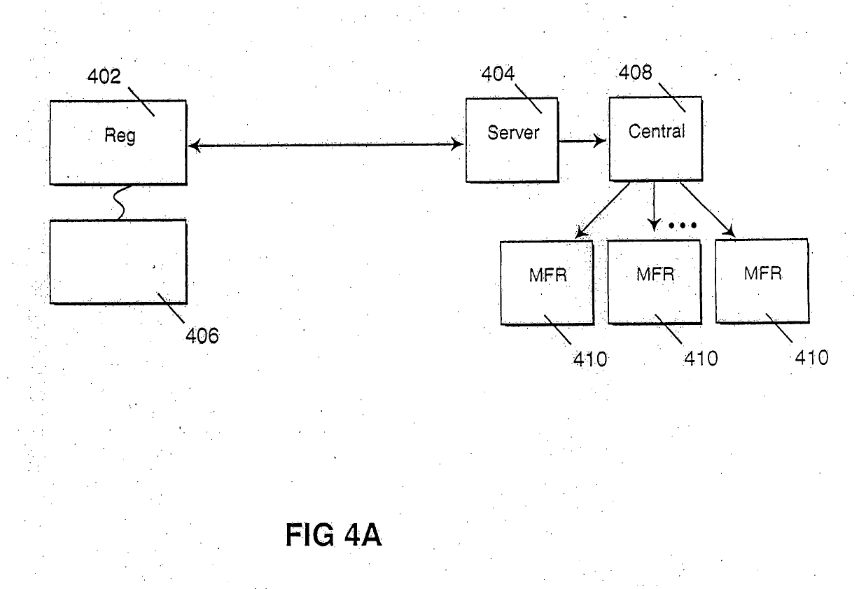

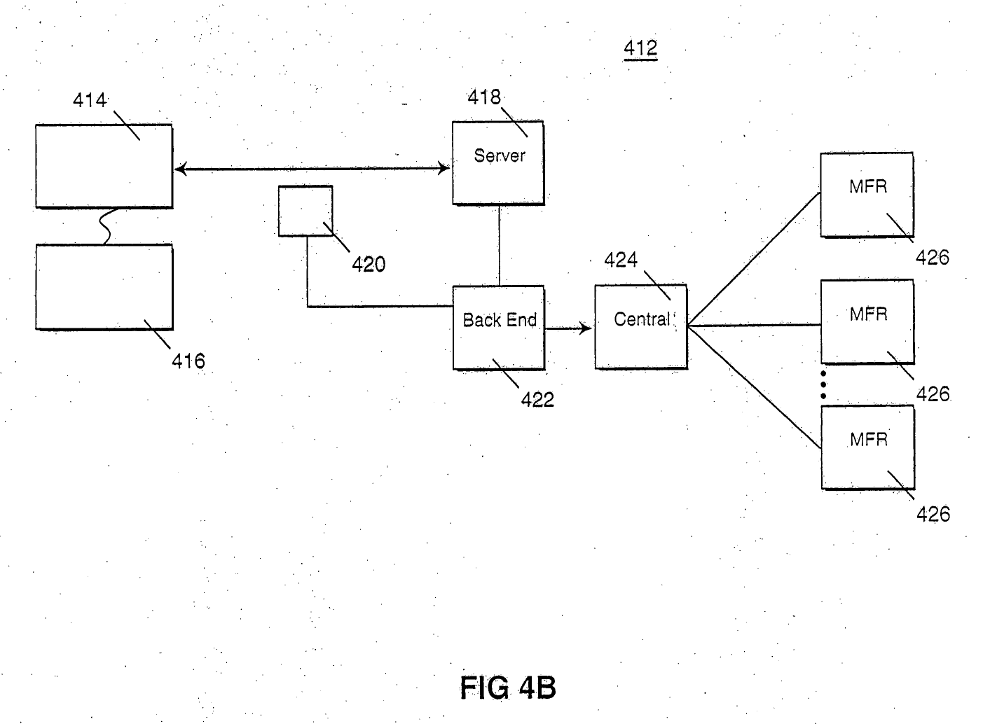

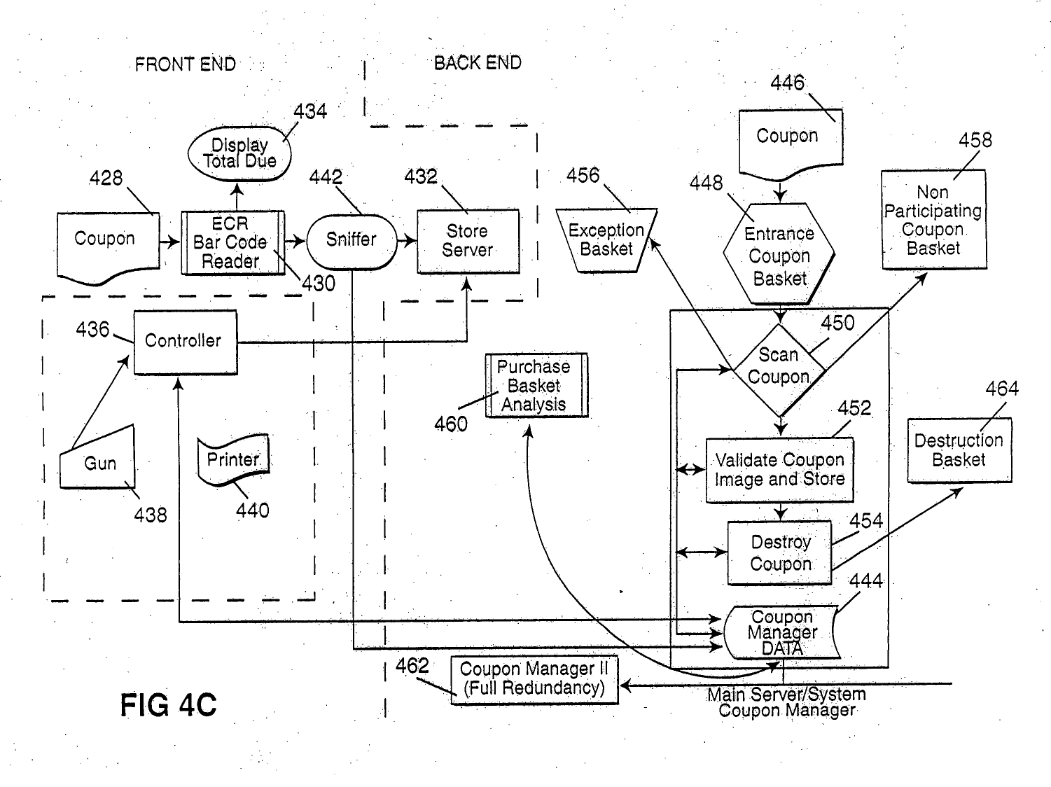

Operations performed by the system of FIG. 1 will now be described with reference to FIGS. 2A and 2B. The purchase basket analysis and coupon manager II will be described with reference to FIG. 4C.

In FIG. 2A, coupons 202 are read by an ECR (Electronic Cashier Register) bar code reader 204 which may be coupled to a cash register in the front end 102. The information corresponding to the bar code of the coupon is transferred to store server 206. The store server 206 authorizes the discount transaction and forwards the discount amount to the cashier register.

The bar codes may be decoded using a sniffer 208 which may be a line tap between the cash register and the store server 206. Bar code information detected by the sniffer 208 is coupled to a buffer 210 of the back end apparatus 104 which stores the bar code information. In addition, the transactional information may be stored in the buffer 210.

The back end apparatus 104 receives the coupons 202 at input 210 (110) and processes the same. The processing is generally indicated by reference numeral 212 wherein the coupons are scanned at 214, validated at 216 and destroyed at 218. The coupons are determined as valid on the basis of the data in the buffer 210 (122). Destroyed coupons are directed to the destruction basket 220. It is also possible that the data of the valid coupon images are stored in the buffer 210. Coupons determined by the processing as being redeemable by non-participating manufacturers are directed to the non-participating coupon basket 222 (124). Coupons determined as anomalous such as coupons which have no transaction associated therewith are forwarded to the exception basket 224 (126).

FIG. 2B shows the coupon and information flow which may be performed in the back-end 104. In step S226, the coupons are input. The coupons are imaged in step S228 and stored in step S230. Coupon validation is determined in step S232 and, if invalid, are directed to the exception bin in step S234. If the coupons are anomalous, they are forwarded to the non-participating bin in step S236. If the coupons originate from a non-participating manufacturer, they may be sent to the non-participating bin in step S238 which is reserved for future applications. The coupons may be validated in accordance with the company, family, value codes or the expiration date. Upon validation, the valid coupons are destroyed in step S240 and forwarded to the destruction bin in step S242. Reports are generated in detail and/or summary in step S244 based on the results of the processing in steps S232-240 and the reports may be electronically transferred to the manufacturer in step S246.

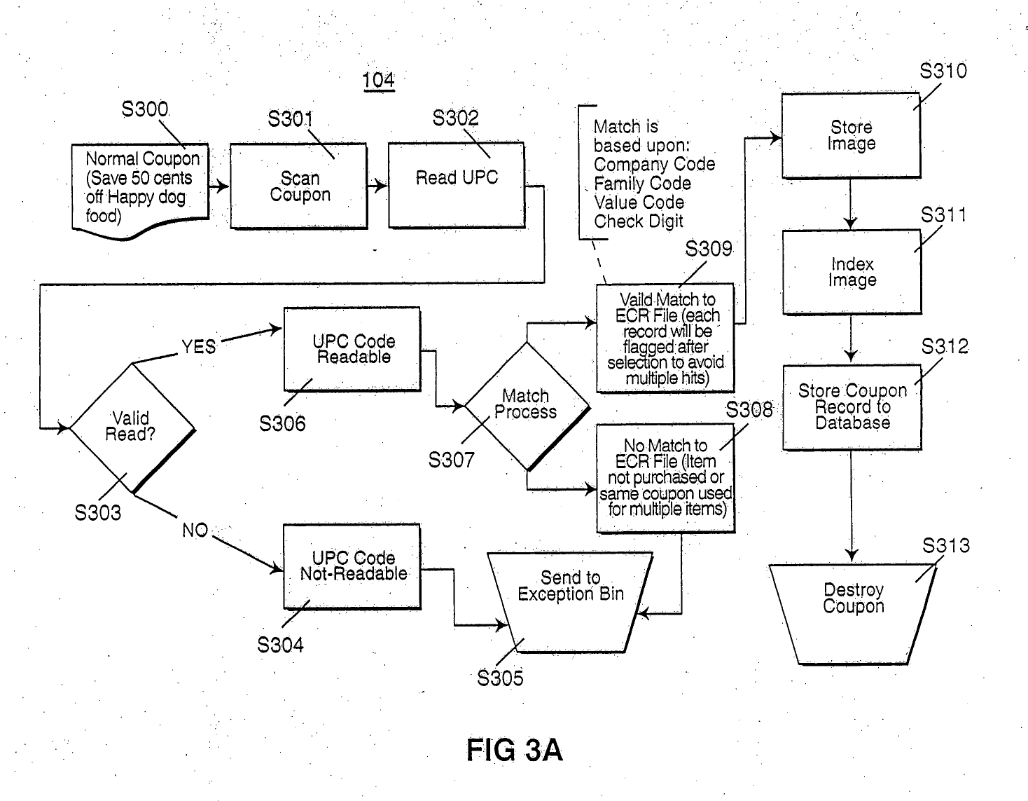

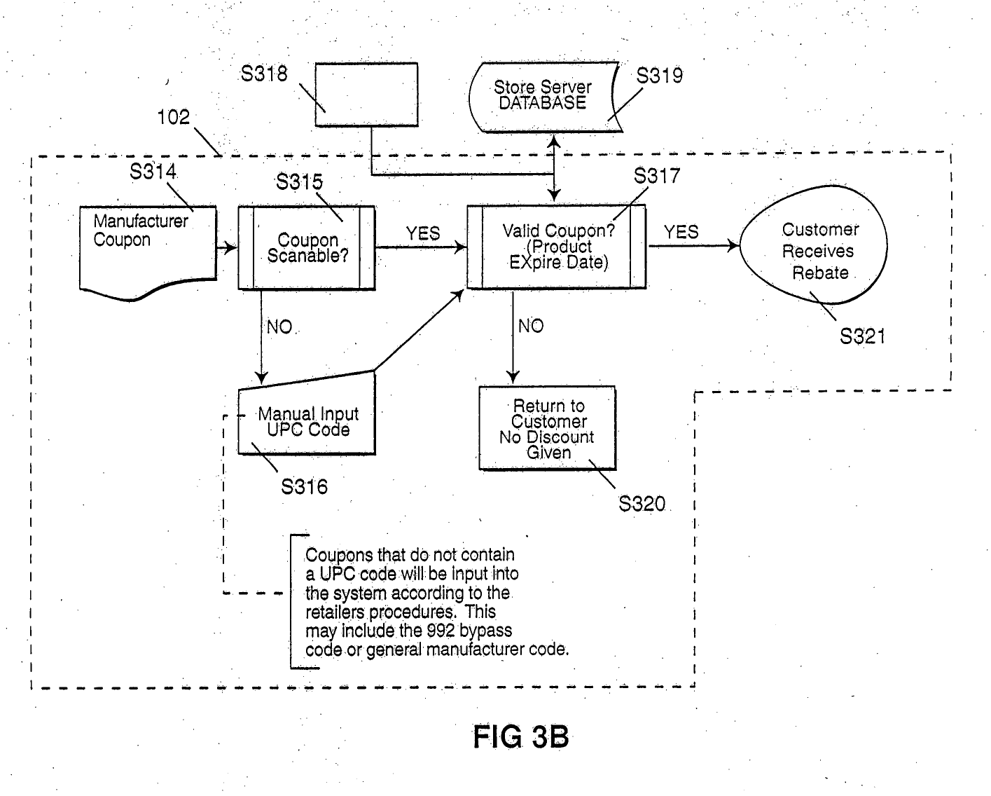

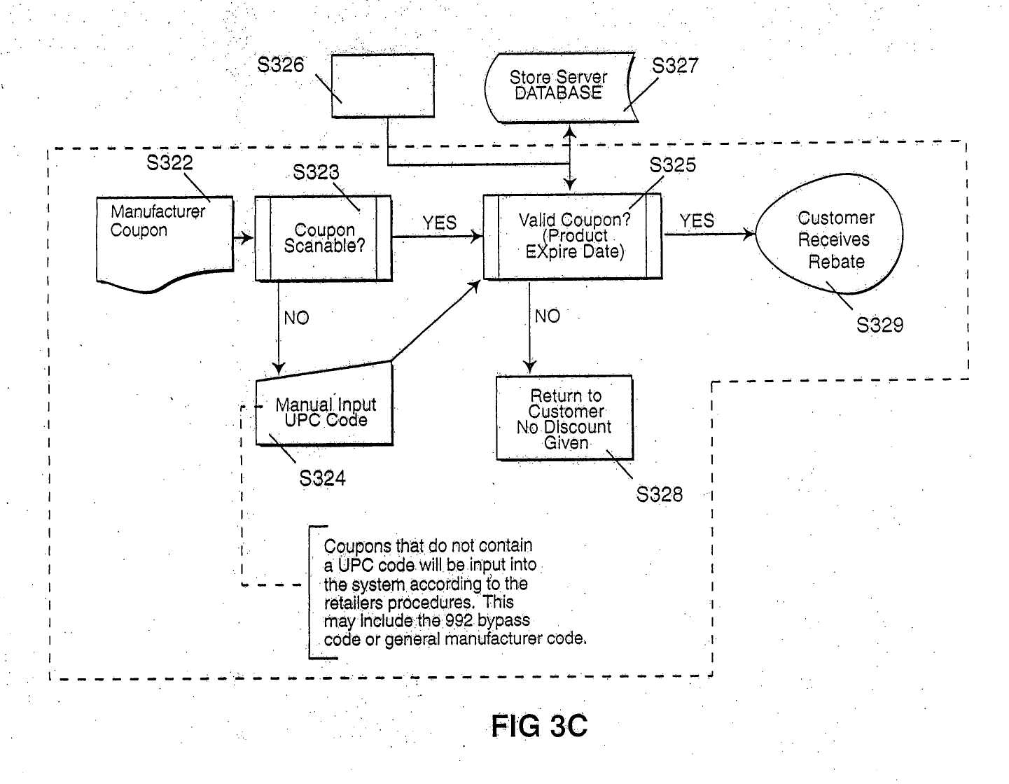

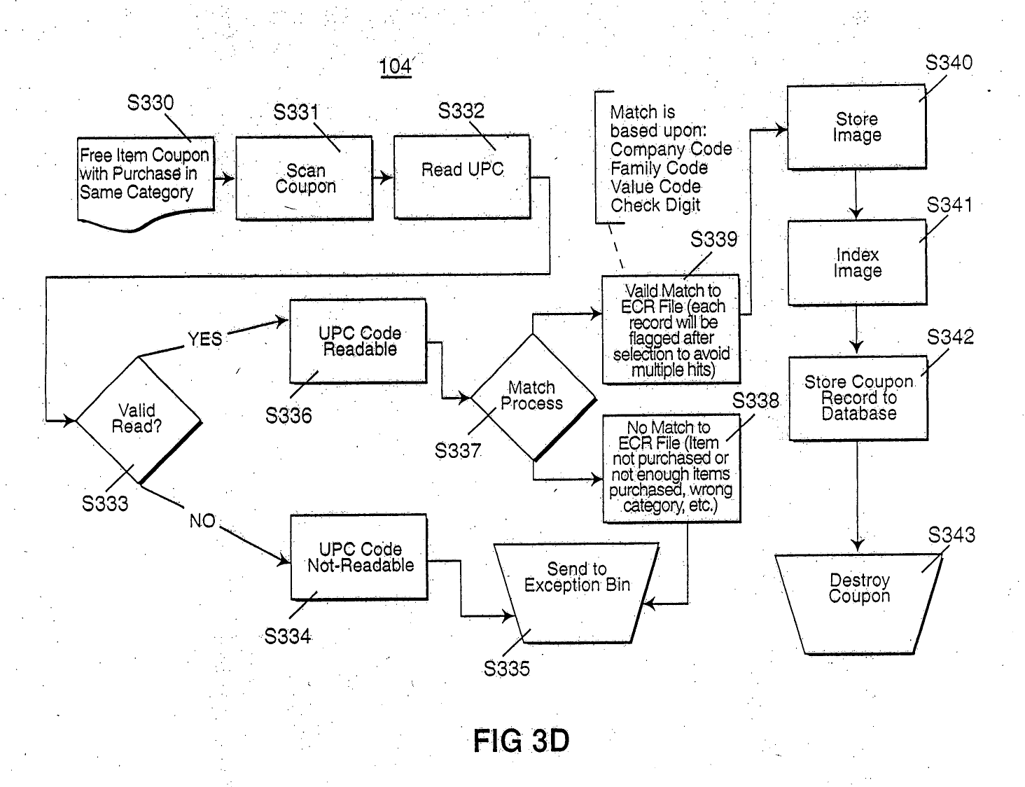

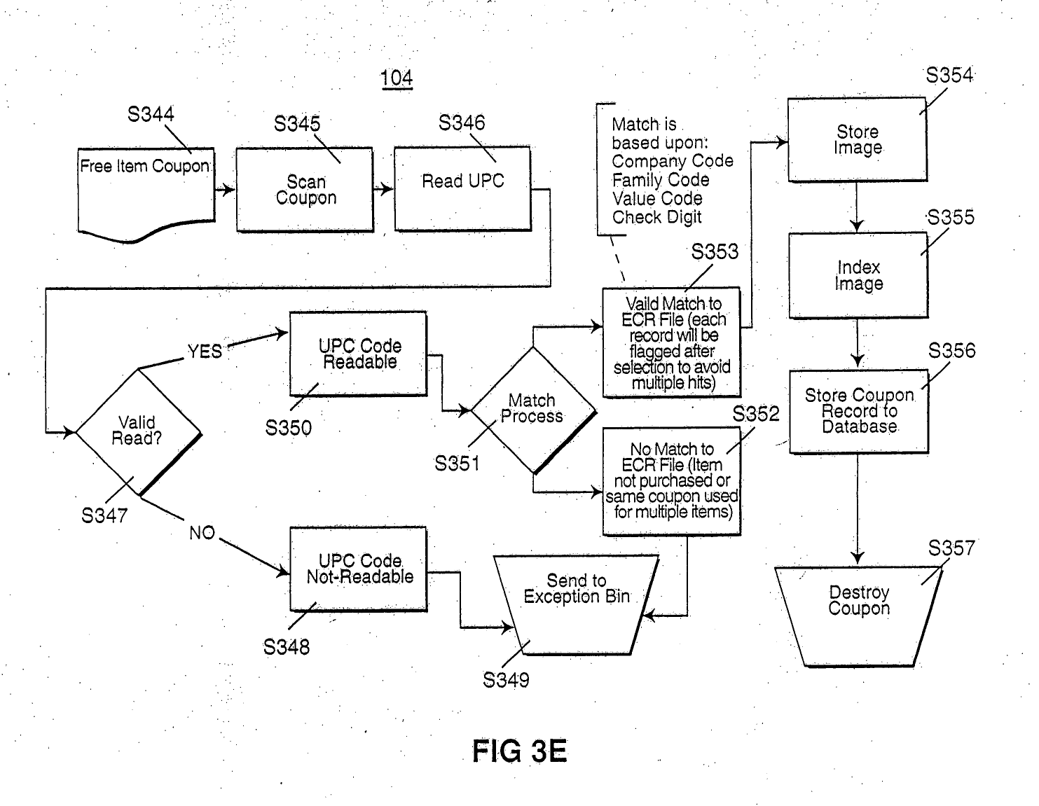

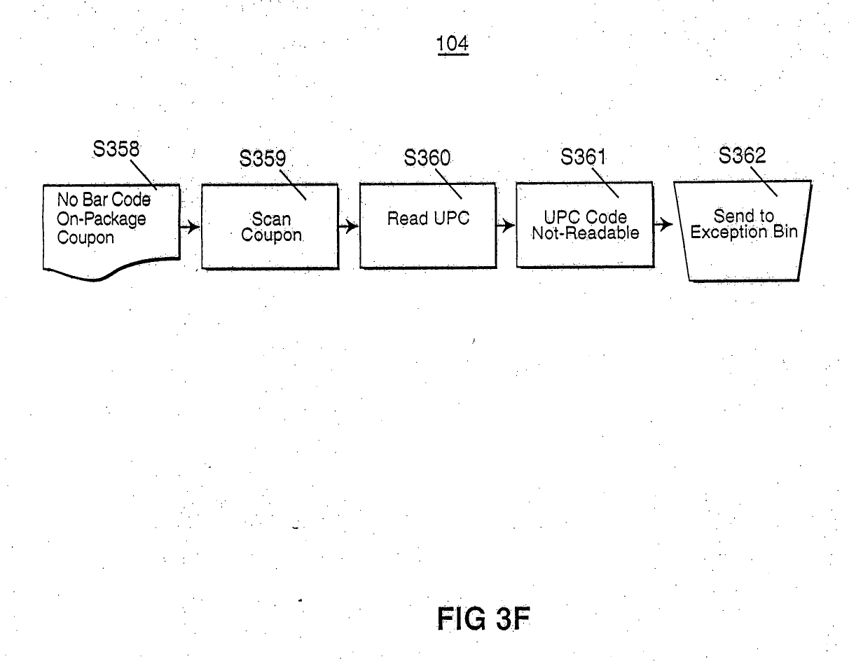

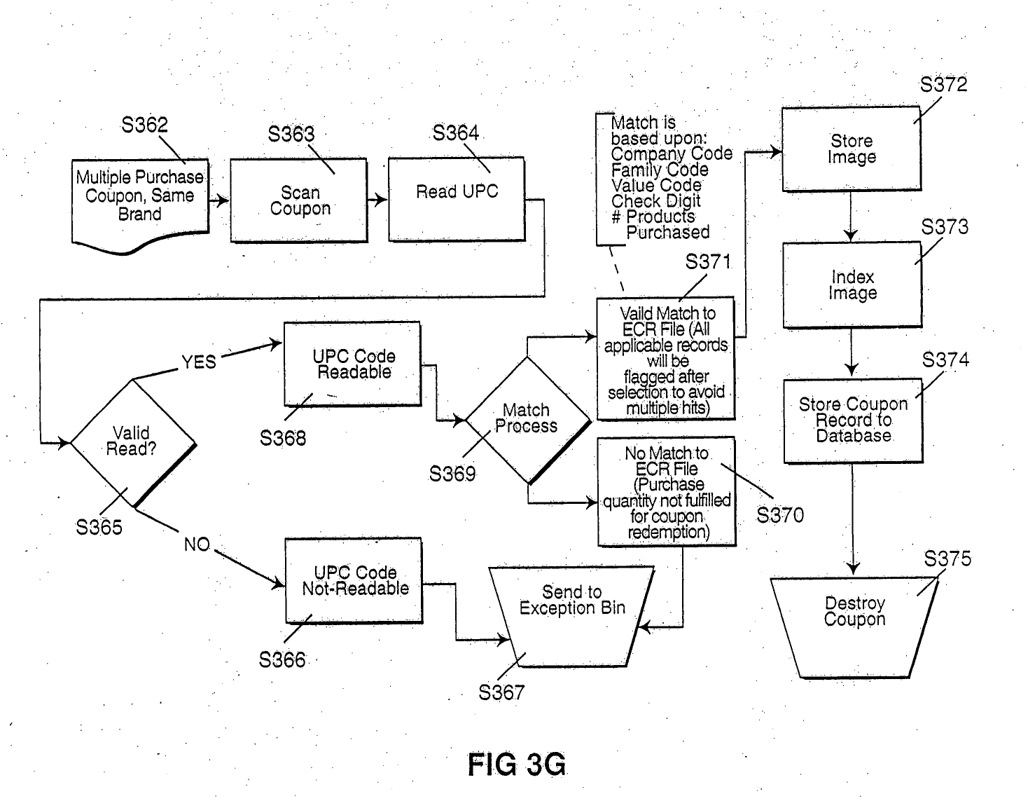

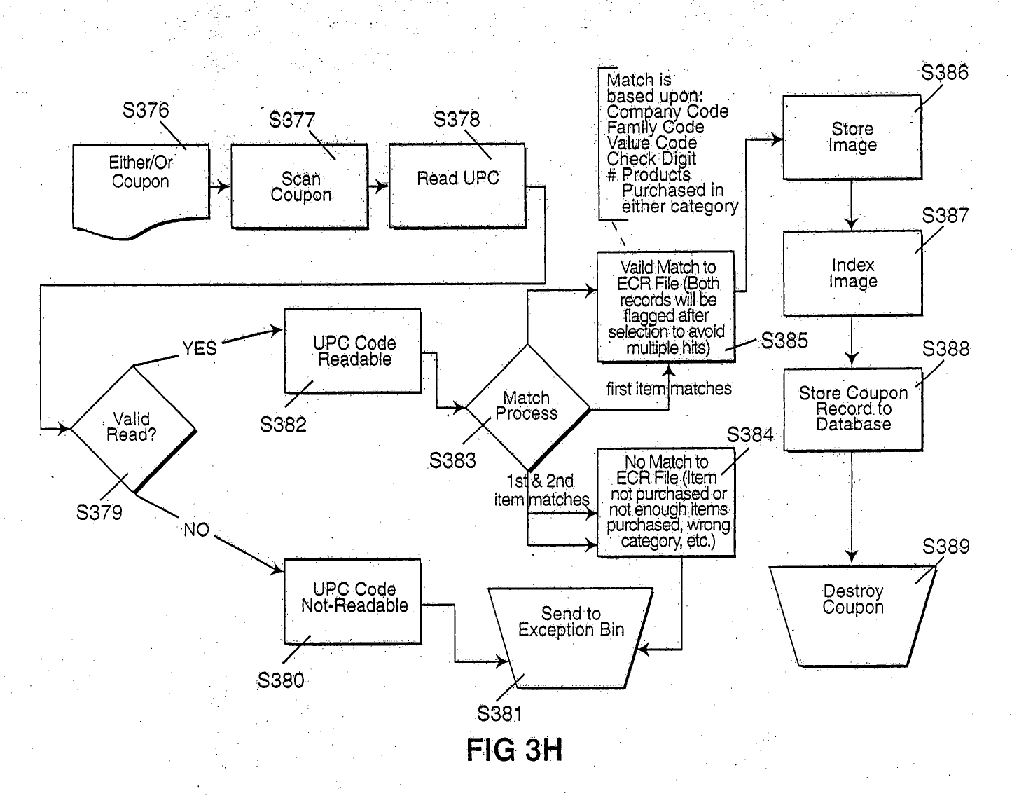

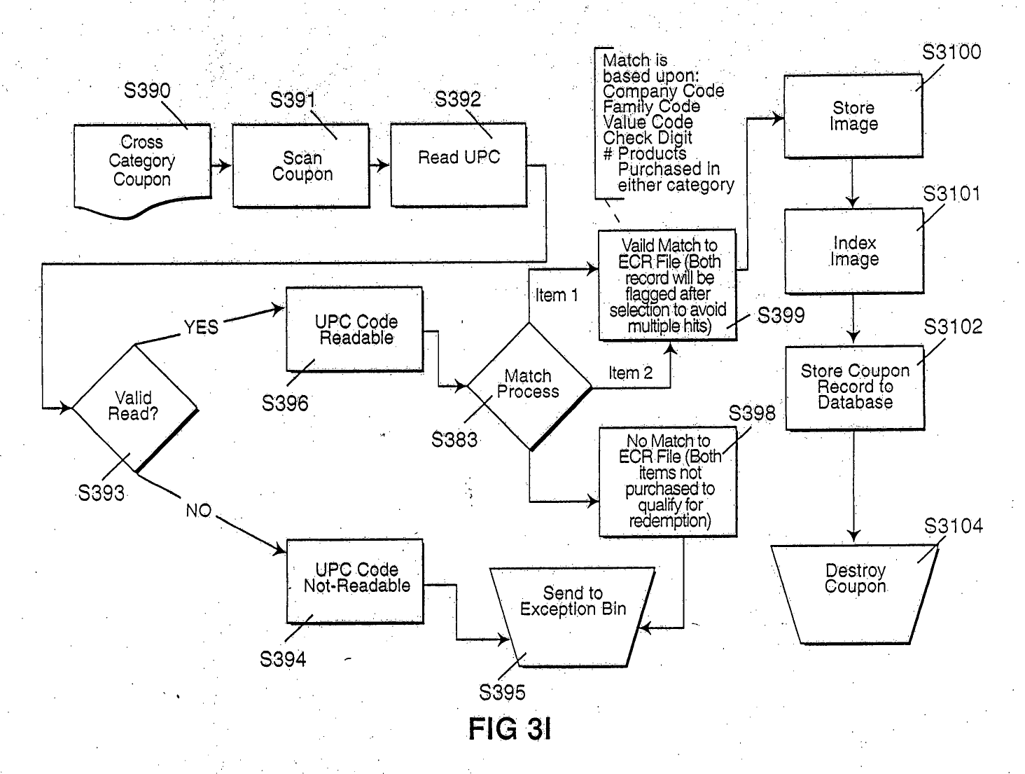

The processing of different types of coupons is explained with reference to FIGS. 3A-I. It will be appreciated that the present invention is not limited to the particular types of coupons illustrated and may include other types of coupons as well.

FIG. 3A sets forth the processing steps for processing normal coupons. According to the present invention, normal coupons offer discounts to potential consumers for a product identified on the coupon as indicated by a bar code. In step S300, the normal coupon is identified. The normal coupon in step S301 is scanned and the UPC is read in step S302. In at least one embodiment, the scanning and reading is performed digitally. It is determined in step S303 whether the coupon has been validly read. When the coupon is not validly read, information representing this state is generated and stored by the processor 114 into memory 116 in step S304 and the coupon is forwarded to the exception bin in step S305. If the coupon is validly read, information is generated indicating that the coupon is readable in step S306.

In the matching process of step S307, the coupon is matched to a transaction at the point of sale. In at least one embodiment, the matching process matches the coupon to the corresponding transaction at the point of sale. In the alternative, the matching process arbitrarily assigns coupons to transactions based on the type of transaction rather than matching actual transactions with corresponding coupons. When no match is detected, information is generated and stored to the ECR file in step S308 and the coupon is forwarded to the exception bin in step S305. However, if a match is detected, processor generates and stores information indicating valid matches in the ECR file in step S309. In at least one embodiment, a record of the valid and/or invalid matches is maintained and checked in the matching process of step S307 to prevent the same coupon from being used for a multiple of items or times. In step S310, the scanned image of the validly-matched coupons are stored in memory 116 (FIG. 1). In step S311, the stored images are indexed for easy access. The coupon records are stored in a database in step S312 and the valid coupons are destroyed in step S313.

FIG. 3B sets forth the steps for processing “manufacturer” coupons. Manufacturer coupons are input at step S314 and scanned at step S315. If the coupon is not scannable, the code (such as a UPC code) is entered manually in step S316. In at least one embodiment, the manual input may include a so-called 992 bypass code or a general manufacturer code. In either case, processor control advances to step S317 where it is determined whether the coupon is valid based on validity information received from a device in step S318 or the buffer 210 (FIG. 2A) in step S319. Such validity information may include the product, the expiration date and/or the manufacturer. Invalid coupons are returned to the customer with no discount in step S320; whereas, if the coupon(s) is valid, customers receive the discount, credit or rebate in step S321.

FIG. 3C sets forth the processing steps for processing “in-store” coupons. An in-store coupon is redeemed directly by the retailer or by a local entity such as a distributor in contrast with a national or regional coupon which is redeemed by a manufacturer. Heretofore, clearinghouses erroneously disposed of in-store coupons although directed to return such coupons to the retailer. The present invention advantageously processes in-store coupons. Steps S322-329 are similar to the steps in FIG. 3B except the processing in step S325 processes the in-store coupon.

FIG. 3D illustrates the processing of “free-item with purchase in the same category” coupons (hereinafter “free-item coupons). The free-item coupon credits the consumer to receive a free item with the purchase of another item in the same category. The process is substantially the same as shown in FIG. 3A for processing a normal coupon except that the processing in step S337 stores the credit in memory 216 (FIG. 2A) to the customer for the category of the item purchased. This category may be, for example, food groups, appliances, electronics, clothes or other retail goods. The credit may be stored in a database temporarily in the buffer 210 (FIG. 2A), for example.

FIG. 3E shows the processing steps for processing a “free-item” coupon. The free-item coupon entitles the consumer to a free item. It will be appreciated that steps S344-S357 are similar to the steps shown in FIG. 3A for processing the normal coupon except that the processing in step S351 stores the credit of the free item to the customer.

FIG. 3F sets forth the processing of coupons which have no bar code on the package. It will be appreciated that the processing steps S358-S362 are a subset of FIG. 3A wherein it is decided that the bar code is not readable in step S361 and the coupon is sent to the exception bin in step S362. In the present invention, the coupon may be accepted in any event by manual input as set forth in steps S316 and S324 of FIGS. 3B and 3C.

FIG. 3G sets forth the steps S362-S375 for processing “multiple purchase” coupons of the same brand. A multiple purchase coupon for the same brand entitles a consumer to apply the coupon a multiple of times to the same brand. Multiple purchase coupons may also be applied to other brands, manufacturers or categories. It will be appreciated that the processing steps are similar to the processing steps for a normal coupon as in FIG. 3A except that the processing in FIG. 3G stores the information crediting the number of times the coupon may be applied to any number of future transactions.

FIG. 3H sets forth the steps S376-S389 for processing “either/or” coupons which is similar to processing of the normal coupon in FIG. 3A. Either/Or coupons entitle the consumer to receive a discount for one or more of a plurality of goods. As illustrated in step S383, first and second items are matched separately to different transactions. If the first item matches a transaction, then processing proceeds to step S385 for the first item. Similarly, if the second item matches a transaction, then processing proceeds to step S385 for the second item. Otherwise, the processing proceeds to step S384 for either the first or second item which does not match a transaction.

FIG. 31 sets forth the steps S390-S3103 for processing “cross-category” coupons which is similar to processing of the normal coupon in FIG. 3A except that in step S397 the processor determines whether the coupon applies to the category of the item to be purchased. A cross-category coupon entitles the consumer to receive a discount for goods in different categories, such as groceries, appliances, clothing, electronics or the like. The categories may also be groups such as food groups, appliance groups, clothing groups or electronics groups or the like. The processing stores the categories within which the consumer is entitled to a discount.

The booklet of the present invention may be utilized with the coupon manager system 100 described with reference to FIGS. 1-3. However, the booklet of the present invention is not limited and, alternatively, may be utilized with other systems such as those shown in FIGS. 4A and 4B.

FIG. 4A illustrates a non-integrated system 400. In such system, sales transactions may be scanned by scanner 406 at cash register 402 and transferred and recorded to store server 404. Such arrangement may be easily incorporated into an existing store. The system of FIG. 4A includes a central processing computer 408 which is coupled to the store server 404 by any suitable means including wired or wireless communication.

In operation, the central processing computer 408 stores predetermined information relating to discounts in the store server 404. As items or goods are scanned using scanner 406, associated transactional information is forwarded to the store server 404. When the scanner 406 scans a discount coupon, recognized by the UPC code, the store server 404 accesses the information stored therein to determine whether the coupon is redeemable. In at least one embodiment, the coupon is a booklet of discounts with a single UPC code Such booklet is more fully described hereinafter.

FIG. 4B shows an integrated system 412 of the present invention. Similar to the system of FIG. 4A, the integrated system includes a cash register 414 and a scanner 416 in communication with the store server 418. In this embodiment, a tap 420 (which may be a line tap) taps the communication between the cash register 414 or scanner 416 and the store server 418. Back end apparatus 422 determines whether the information received identifies the booklet of the present invention and/or discounts for items. The store server 418 determines the discount based on the discount information forwarded by the back end apparatus. The discounts are relayed to the cash register 414. The back-end apparatus 422 may be similar to the back end apparatus shown in FIG. 1 and may operate similarly. A central processing computer 424 is coupled to the back end apparatus 422 for processing the discount information. The central processing computer 424 may be similar to the central processing computer shown in FIG. 1 and may operate similarly. The processed discount information is forwarded to the respective manufacturers 426 for settlement. As in the embodiment of FIG. 1, various reports relating to the discount information may be forwarded to the manufacturers.

The discount information and the reports prepared by the central processing computer 424 may be available or supplied to the manufacturers by way of a website on the internet or on-line service. The discount information may include, for example, information corresponding to the total redemption value owed to a particular retailer and/or the break down of the discounts. The website, or as a stand-alone application, may enable electronic fund transfer capability which electronically transfers funds between the retailer, manufacturer and service corporation based on account balances generated by the processing. Processing of the booklet will now be further explained with reference to FIG. 4C.

Coupons or booklet 428 are scanned by ECR bar code reader 430. The scanned bar code information is supplied to store server 432. The store server 432, based on a comparison result to be explained, outputs to display 434 the discounted value of the items to be purchased. Alternatively, a gun 438 may be provided for scanning the bar code of the booklet 428 wherein a controller 436, based on a comparison to be explained, determines which products if any are to be discounted and forwards the information to the store server 432. A printer 440 may be provided to print information corresponding to the discount. A tap 442 (which may be a line tap) taps the communication between the reader 430 and the store server 432 to obtain transactional information and forwards the same to a buffer 444 for storage thereat.

The scanned coupons may be supplied to an input coupon basket 448. A scanner 450 scans the coupons and the processor validates the coupons at 452 based on the data stored in the buffer 444. Valid coupons are slated to be destroyed in 454 and forwarded to a destruction basket in 464. Similar to the embodiment of FIG. 1, an exception basket 456 and a non-participating basket 458 are provided. In addition, a purchase basket analysis processing is performed 460 based on the information in the buffer 444 which determines the purchases. A secondary back end apparatus 462 which repeats or simultaneously performs the processing hereindescribed may be provided for full redundancy.

As is to be appreciated, finding, cutting out, and carrying a large number of coupons may be inconvenient for a customer. The present invention provides a booklet which overcomes these disadvantages. Such present booklet will now be described.

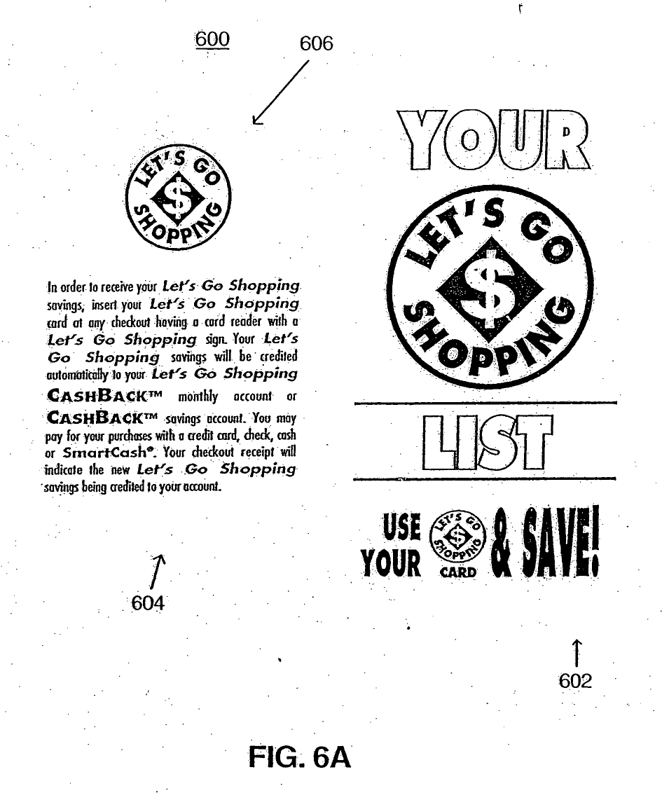

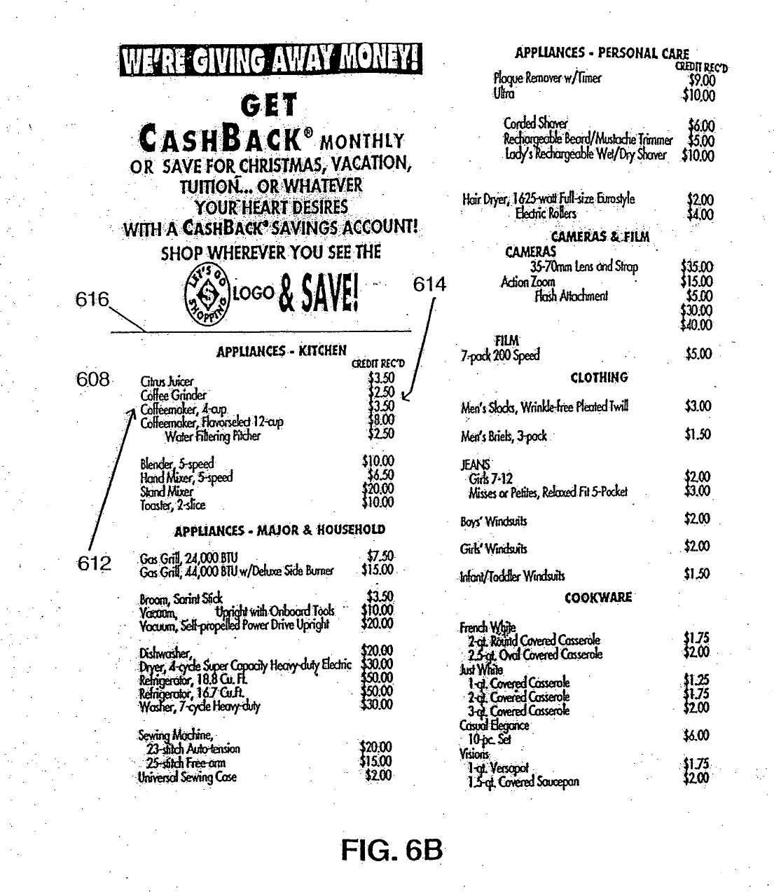

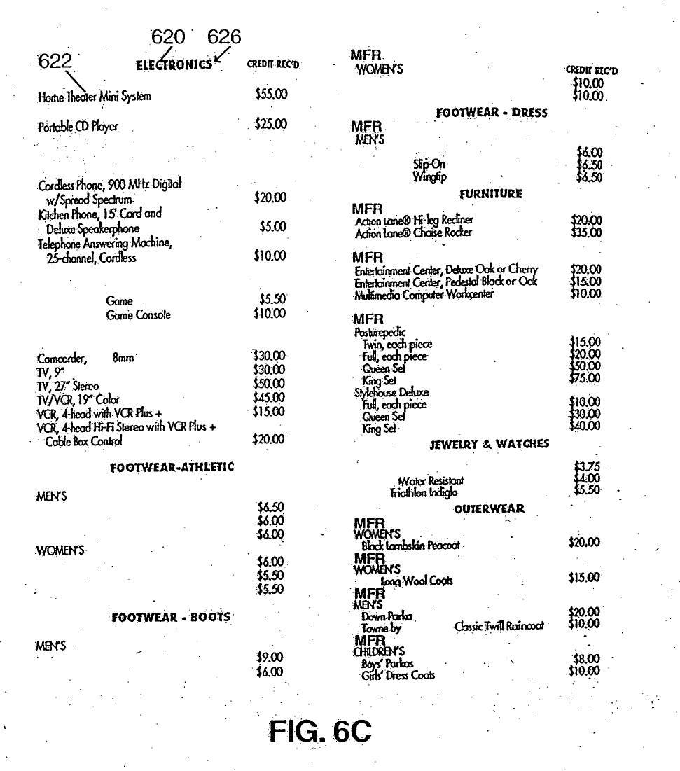

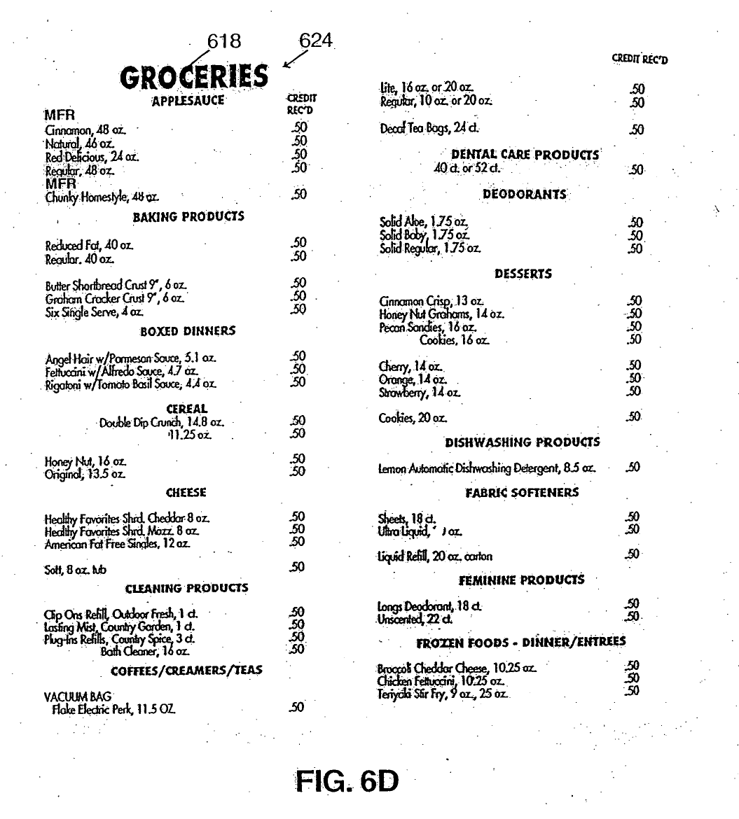

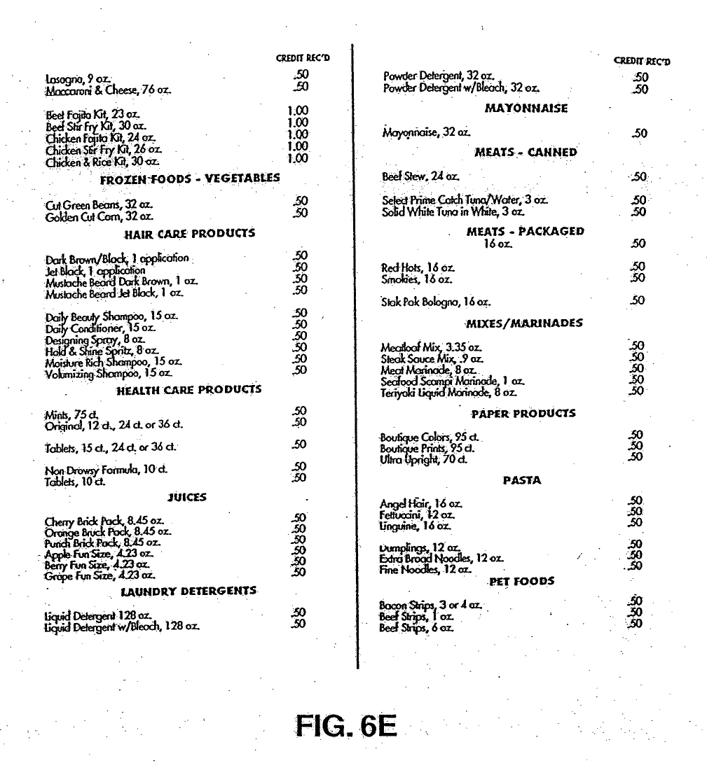

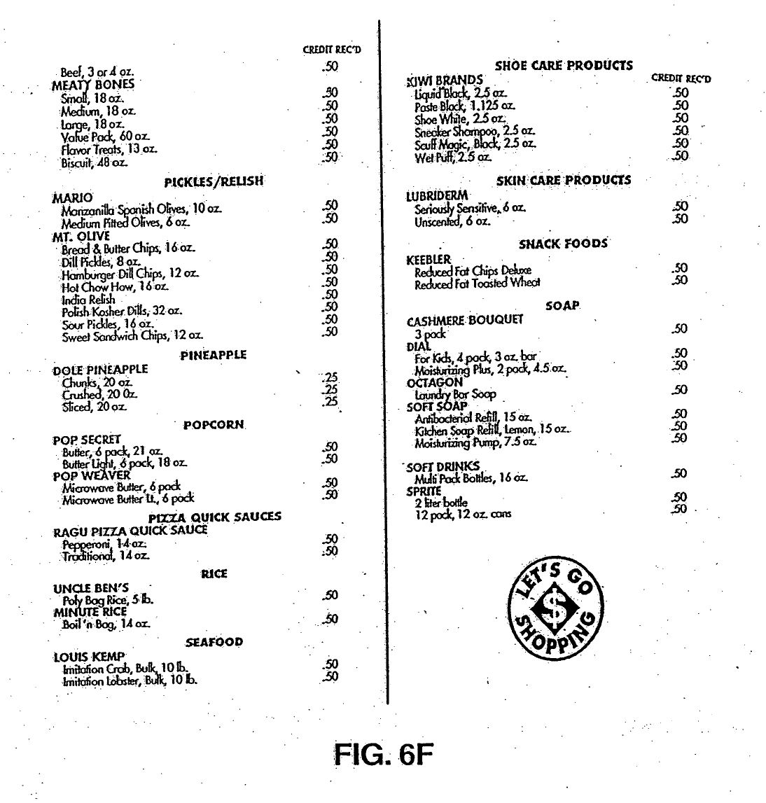

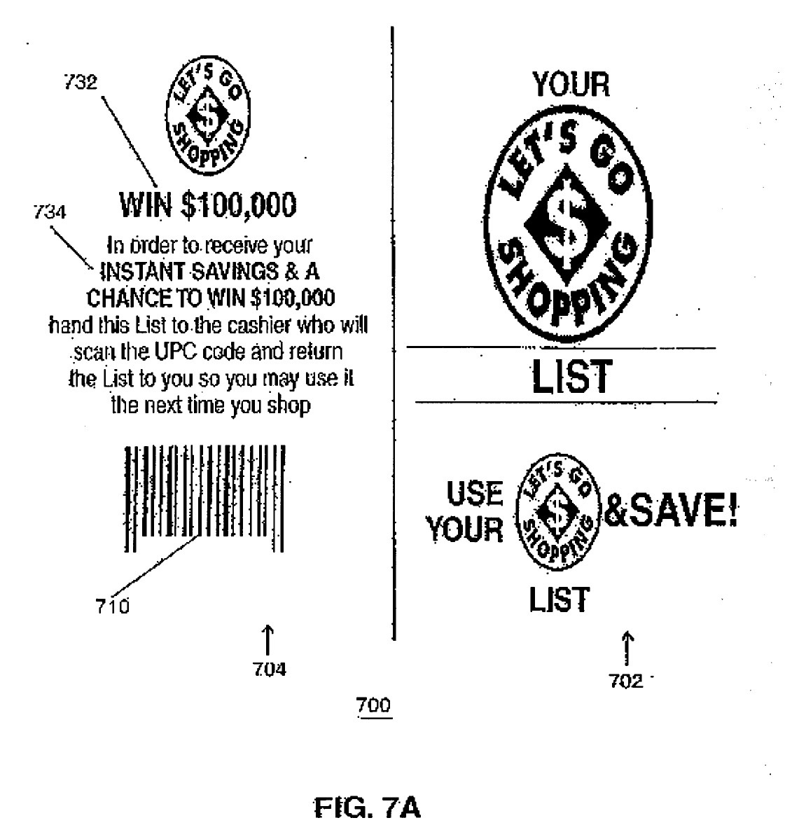

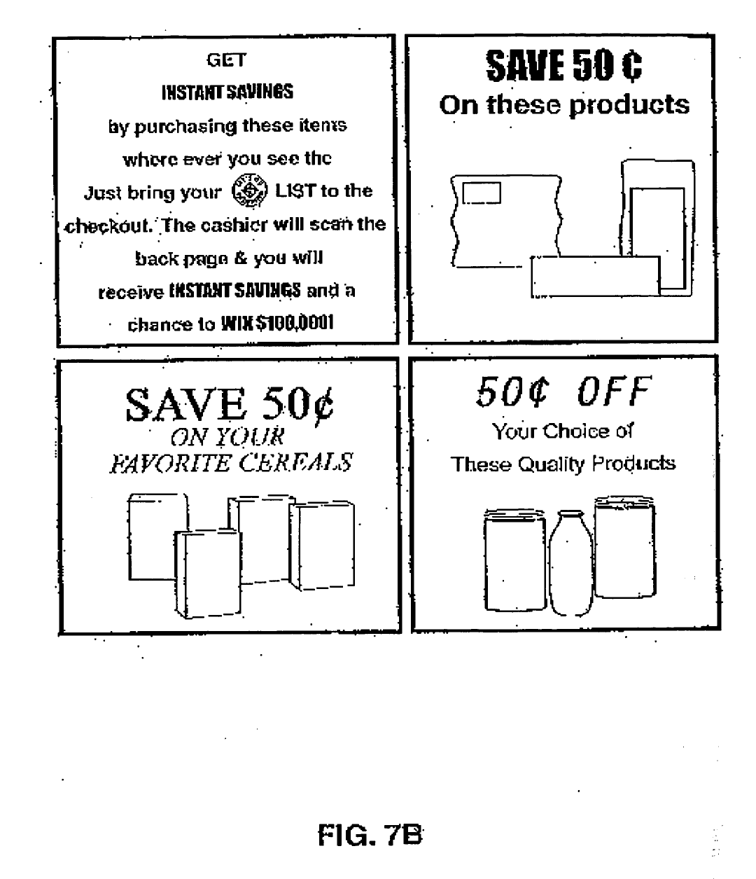

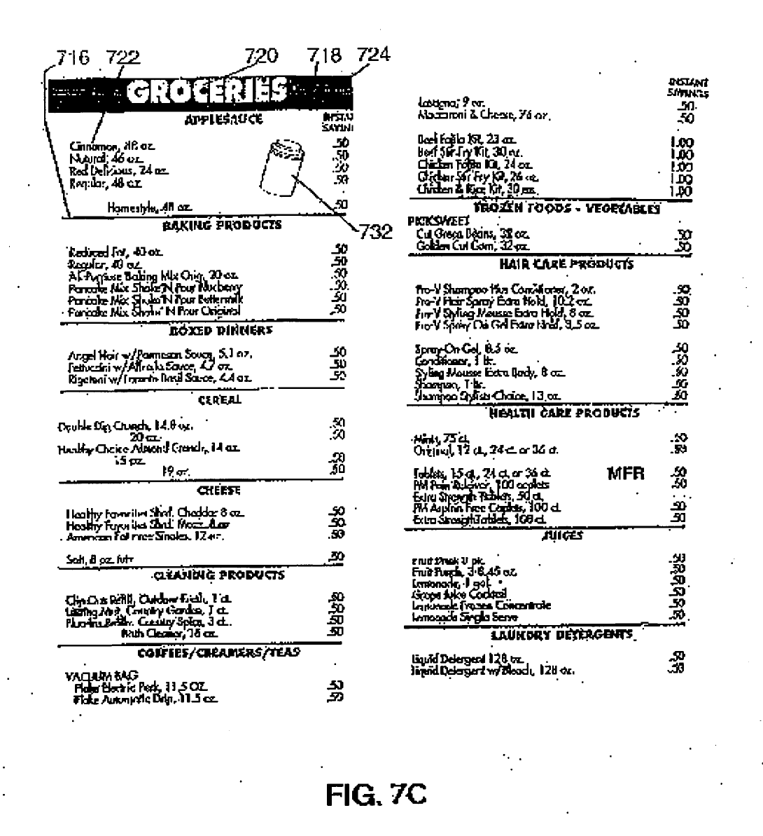

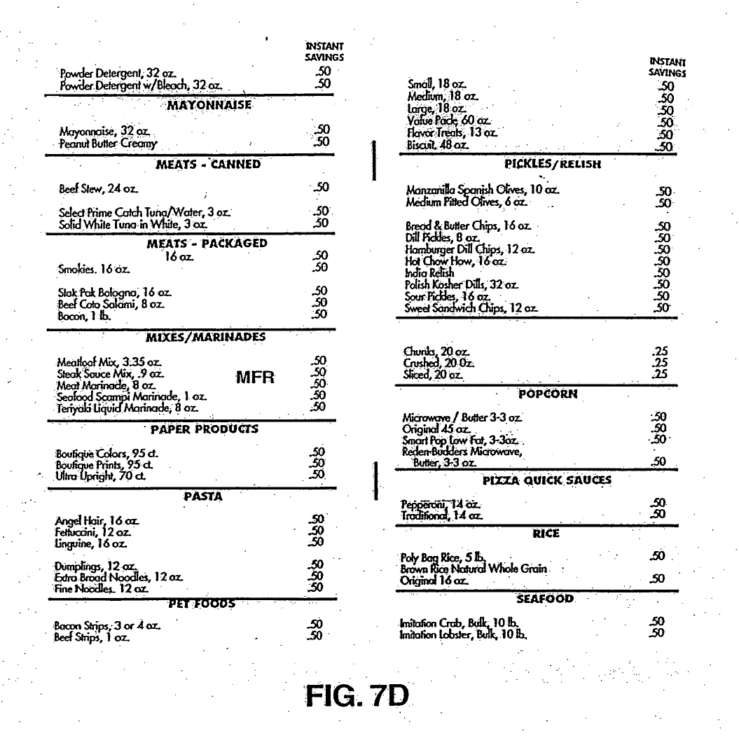

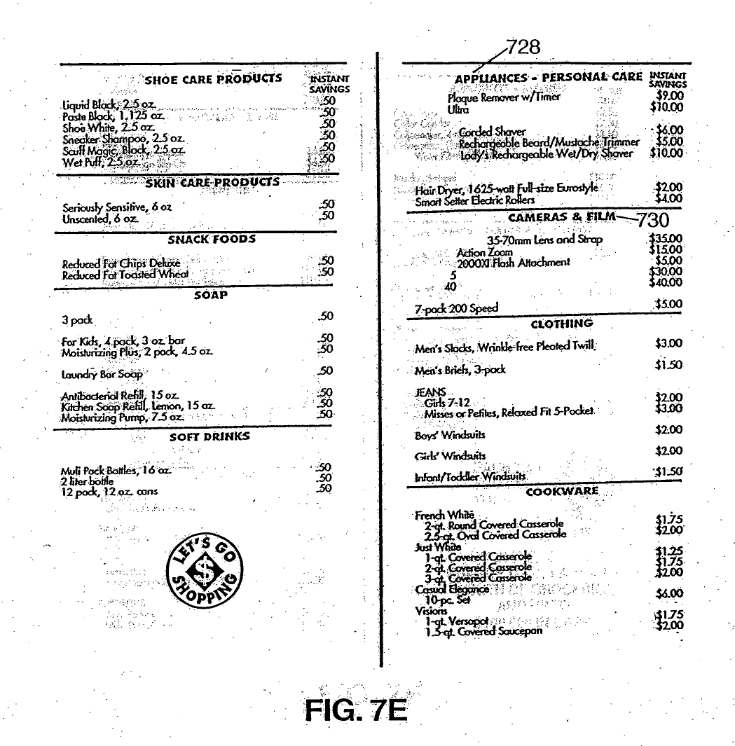

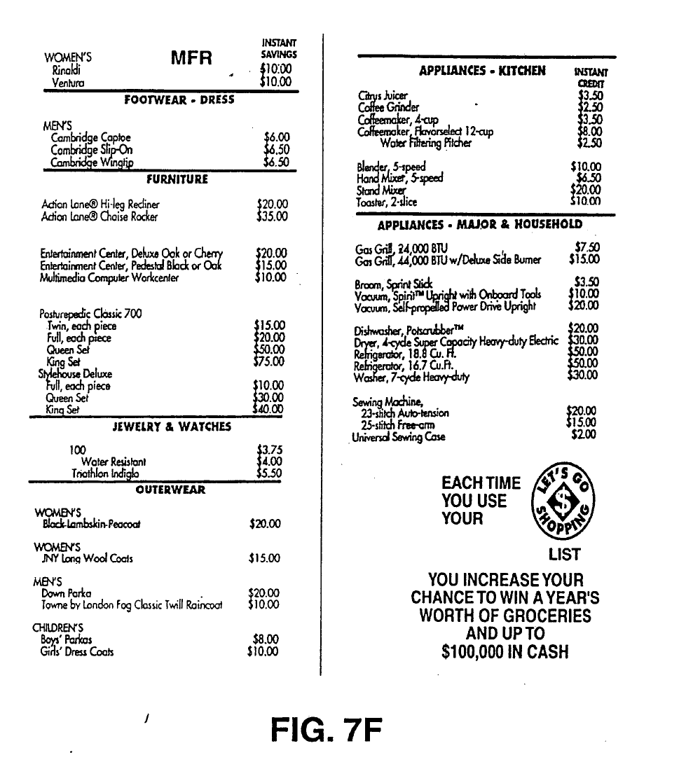

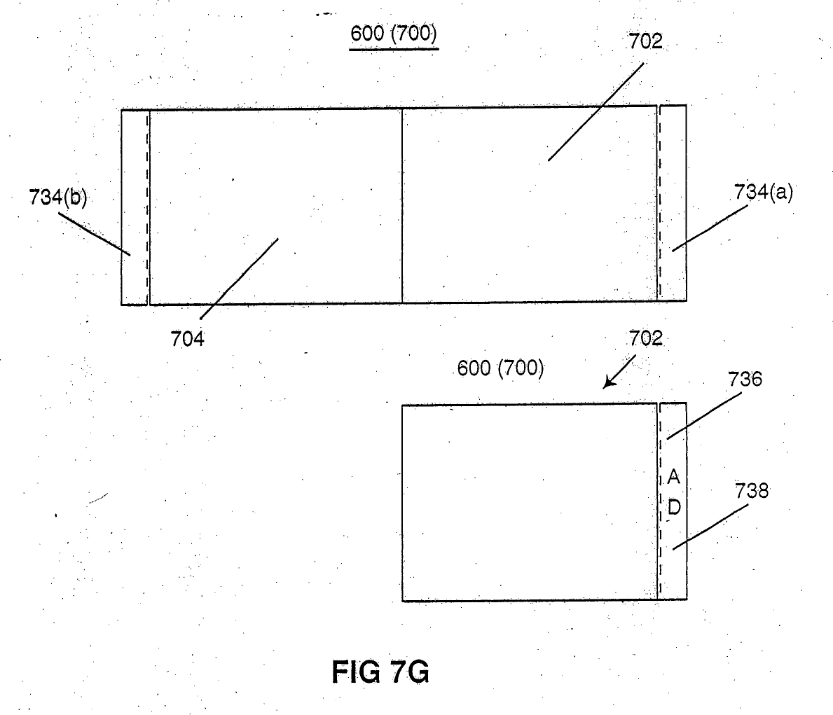

FIGS. 6 and 7 illustrate examples of the booklet 600(700) of the present invention. The coupon booklet 600(700) is envisioned for use by a potential customer to receive discounts for corresponding items in the booklet purchased at any number of stores. The booklet comprises a front cover 602(702) and a back cover 604(704) which share a common edge 606(706). In addition to the front and back covers, the booklet may contain a number of in-between pages such as those shown in FIGS. 6B-F and 7B-F which are coupled to the common edge. As shown in FIG. 6B for example, the booklet includes a listing 608(708) of a plurality of items and prices associated therewith which may present discounts. The listing may also be on the front and back covers or the inside flap thereof. As shown in FIG. 7A, the booklet may include as shown in FIG. 7A, a single bar code 710 for identifying the plurality of items 712 to which the consumer is entitled to discount(s) 614(714) when scanned in a sales transaction. In at least one embodiment, the front and back covers and the in-between pages are coupled together so that the front and back cover and in-between pages are pivotable about the common edge in a book-like manner from an open position to a closed position. It will be appreciated that the single bar code of the booklet of the present invention may be replaced with another form of identification such as a serial number or the like.

A booklet may be considered a small scale edition of a book. Although the booklet may be of any size, as illustrated in FIG. 6 and 7, the booklet may have the dimensions of 3½×6 inches which is found to be a convenient size which is small enough to be carried but large enough not to be misplaced as well as identifiable in a container such as a pocket or hand bag. The booklet may be a collection of sheets fastened together along one edge. The book or booklet may be trimmed at the other edges to form a single series of uniform leaves. In the alternative, the booklet may be a collection of folded sheets bound between covers into a volume. In addition, the booklet may be a stack of sheets of paper interleaved alternately with the material.

The listing of items in the booklet may be formed in an index or table-of-contents form such that the items are organized according to a predetermined manner such as alphabetical order, food groups, discount prices, manufacturer or the like. The index or table-of-contents may be arranged according to the type of product such as groceries, appliances, cameras, clothing, cookware, electronics, footwear, furniture, jewelry, watches, outerwear or the like. Sub-headings may be provided, for example, for each group which are arranged according to a manufacturer, product-line or the like. The index or table-of-contents may be segregated by lateral dividing lines 616(716) shown in FIGS. 6B and 7C, for example, which segregate the different indices or contents according to, for example, category. The lateral dividing lines may be variably-spaced such that an area between adjacent lateral lines is variable.

It is also within the present invention to arrange the items for discount according to combinations of items which the retailer and/or manufacturer wish to combine for sale such as baby food and diapers or peaches and cream. Sometimes it is desired to combine in the booklet undersold items with popular items such as combining pork rinds which are undersold with more popular products such as bacon.

It is within the scope of the present invention to arrange the items for discount with prominent headings 618(718). In at least one embodiment, the headings are prominently displayed in a larger font-size 620(720) than the products 622(722) and/or arranged prior to the respective products. It will be appreciated that this feature of the present invention advantageously allows the potential customer to more quickly identify the goods.

It is also within the present invention to color-code the booklet. For example, the prominent headings may be color-coded with different colors, such as green 624(724) for groceries, blue 626 for electronics, silver 728 for appliances and multi-colors 730 for film and camera products. Although it is shown in the figures that the headings are color coded, portions or entire areas corresponding to, for example, different categories of goods may be color coded. It will be appreciated that color-coding advantageously assists the consumer to quickly locate desired discounts.

The booklet of the present invention may also provide a miniature picture 732 positioned proximate or adjacent the item entitled to the discount. In at least one embodiment, the miniature picture is a miniature of an actual photograph of the product. It will be instantly recognized that the use of such miniature pictures is extremely useful to the consumer in identifying the product. Combined with the index or table-of-contents, the potential consumer quickly determines from the index or table-of-contents the discount information and instantly is made aware and confirms by visually inspecting the miniature picture the product to be purchased.

In addition, or in the alternative, the booklet of the present invention includes additional advertisements and/or information. This may include sweepstakes information or instant savings information 734 which awards the consumer with a prize such as cash or credit or a trip in exchange for particular uses of the booklet in order to entice the consumers to use the booklet. The information may also include coupons 736 prominently displayed in noticeable portions of the booklet such as the inner front page in order to highlight the discount which may be listed in the index or table-of-contents.

The booklet of the present invention includes a single bar code which entitles the consumer to a plurality of the discounts in the booklet. It will be instantly appreciated that this advantageously allows the consumer to carry a single, convenient and compact book representative of a plurality of coupons without the necessity or hassle of carrying detachable or detached coupons. It will further be appreciated that the book arrangement allows the consumer to easily hold the booklet along the common edge in the palm of one hand while flipping through the pages quickly and conveniently as a book rather than detached coupons. In at least one embodiment, the booklet is self-contained and has no detachable parts such that the consumer advantageously maintains all of the information in a neat, compact booklet without the problems of messy, detachable or detached coupons or information.

In addition, the consumer may not need to examine the booklet at all; and may simply submit the booklet upon each shopping transaction for scanning to obtain the discounts which coincidentally are in the booklet. Further, the consumer may use the booklet a number of times which obviates the need for coupon hunting and clipping. The products in the booklet may be discounted once or a plurality of times according to records maintained by the back end apparatus of the present invention.

The bar code may be a UPC code but, alternatively, may be another type of code such as an extended code which contains manufacturer, value or family information. This is particularly advantageous in marketing where the booklets may be mailed to a particular family with a unique family code which identifies for the retailer/manufacturer which family is purchasing a particular product or products. This information may be processed by the present invention and relayed to the manufacturer in the form of a demographics marketing report for future marketing to either the family or region where the family lives.

The booklet of the present invention in at least one embodiment is substantially rectangular in shape having front and back covers with a common edge and pages therebetween. The common edge may be formed of a spine or a folded line of a number of papers. Alternatively, the front and back covers and in-between pages may be coupled together by any suitable fixing method such as staples, glue or a spiral binder or the like. While the booklet of the present invention is shown in FIGS. 6 and 7 as being substantially rectangular with uniform edges, it is within the present invention that the booklet may be in another shape and/or may have non-uniform edges. The booklet of the present invention may include tabs on the pages which may be labeled with an indicator thereby providing an index.

The booklet of the present invention may provide discounts or discounted prices for items purchased. In addition, or in the alternative, the items purchased using the booklet may provide the consumer with other entitlements, including the coupon entitlements described herein with reference to FIGS. 3A-4C. In addition, or in the alternative, the entitlements may be a credit granted to the consumer which may credit an account held electronically for the consumer. A credit may be different from a coupon discount because a credit is applied to a future transaction not necessarily related to the present transaction. Such credit accounts may be, for example, a vacation account which accumulates credit for the consumer for cash value or items purchased at a later date for the consumer's vacation. The account may also be a holiday or birthday account for saving credit for cash value or to be applied to items purchased for a holiday or birthday. The account may be a tuition savings account whereby credits are applied to the tuition of the consumer or relative of the consumer. The credit account may be an account for cash value including an interest bearing account which accumulates interest such as a money market account. It will be appreciated that the credit accounts of the present invention advantageously promotes loyalty of the consumer to the retailer, manufacturer or service corporation.

The system of the present invention may include the manner in which the booklet is distributed and used. In at least one embodiment, the booklet is issued for predetermined time periods such as monthly in ride-along direct mail pieces to consumers. Participating stores which participate in the system may have a list of offers downloaded to either the store server or the back end processor described herein. When the consumer checks out, the booklet is handed to the cashier who scans the single bar code on the booklet. It will be instantly appreciated that this advantageously allows the consumer to obtain any discounts which may be available without the consumer having to find the discount. The system of the present invention may automatically transfer the information and/or the electronic find transfer at predetermined intervals such as nightly. At the end of the predetermined time period, a new booklet is distributed and the previous information is either automatically deleted or replaced by new information. It may be also within the processing of the present invention to establish payment of the booklets, the distribution and/or number of items in the booklet. It is also within the present invention to establish a partnership with a bank or other financial institution to establish savings accounts for consumers from and through direct deposit of the savings the consumer receives by utilizing the booklet in accordance with the credit aspect of the present invention.

The booklet may also include, as shown in FIG. 7G, extended front 702 and back covers 704 which extend past the pages encloseable therebetween. In one embodiment, the extended portion is a tab or opposing tabs 734 (a) and 734(b) formed which may be detachable along a perforated edge 736. An advertisement 738, which may include a coupon, may be provided on the tab. It will be appreciated that the tab easily distinguishes the booklet of the present invention from junk mail.

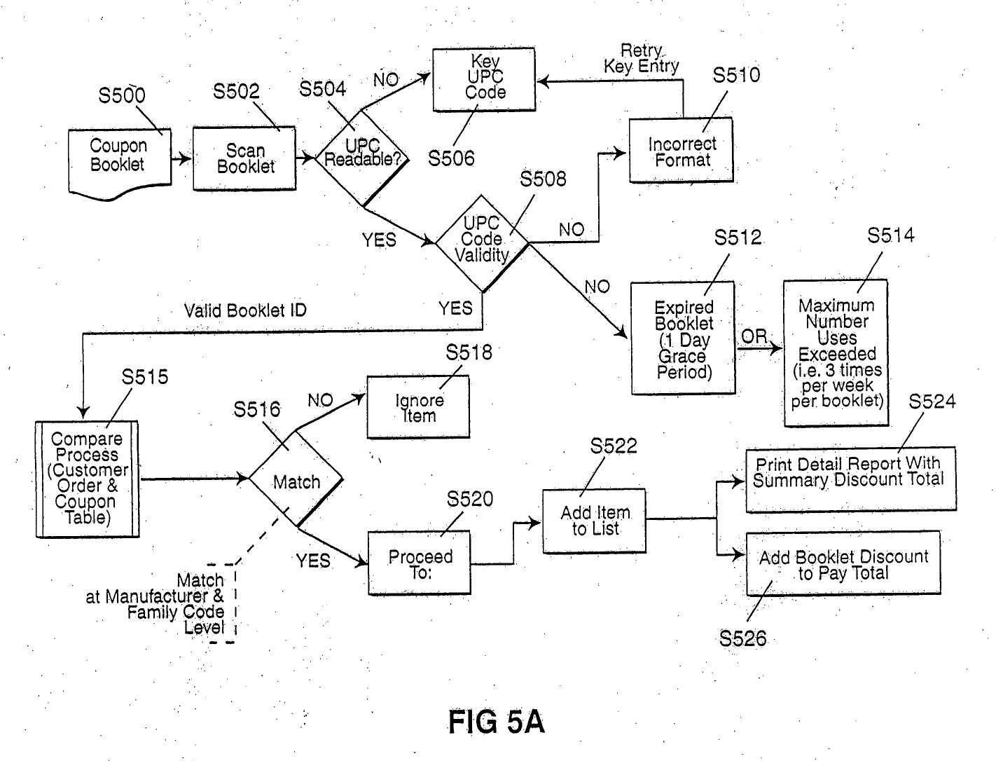

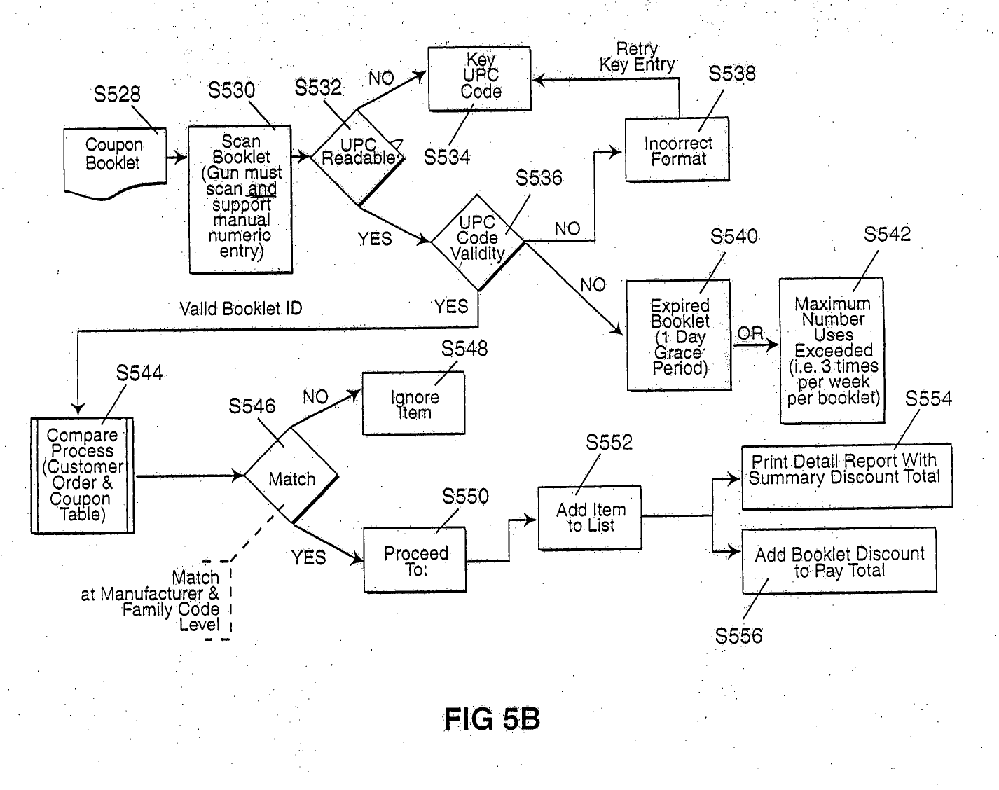

The processing steps for the integrated coupon booklet are shown in FIG. 5A. In step S500, the coupon booklet is presented and in step S502 the booklet is scanned. In step S504 it is determined whether the bar code, such as a UPC, is readable and in step S506 the operator manually keys in the booklet bar code when unreadable. In step S508, it is determined whether the bar code is valid and, when invalid, it is determined that an incorrect format of the bar code is scanned in step S5 10 and manual entry of the bar code by, for example, a keypad is retried in step S506. In the alternative, when it is determined that the bar code is invalid it is further decided that, for example, an expired booklet is granted a grace period such as one day or week in step S512 and/or the maximum number of uses of the booklet is extended in step S514. The results of the processing in steps S512 and S514 are recorded and may be reported in the report(s).

When it is determined that the bar code is valid, processing in step S514 compares a customer order to a coupon table which may contain one or more pieces of discounting information relating to a discount, credit or rebate relating to a particular item. The table may be downloaded/updated by the central processing computer of the present invention. When no match is determined in step S516 between a particular sales transaction and coupon information, the discount for that item is ignored in step S518. Otherwise, control advances to step S520 wherein the discount is authorized. In step S522, the item authorized for a discount is added to a list. In step S524, detailed and/or summary reports of the discounts are stored and/or printed and in step S526 the booklet discount is added to a total to be forwarded to a particular manufacturer for redemption.

FIG. 5B sets forth steps S528-S556 for processing coupons or booklet (see FIG. 5B) according to the non-integrated system which are similar to the steps set forth in FIG. 5A.

The present coupon processing may be set forth in a computer program which may be stored in a suitable medium such as an optical disk or the like.

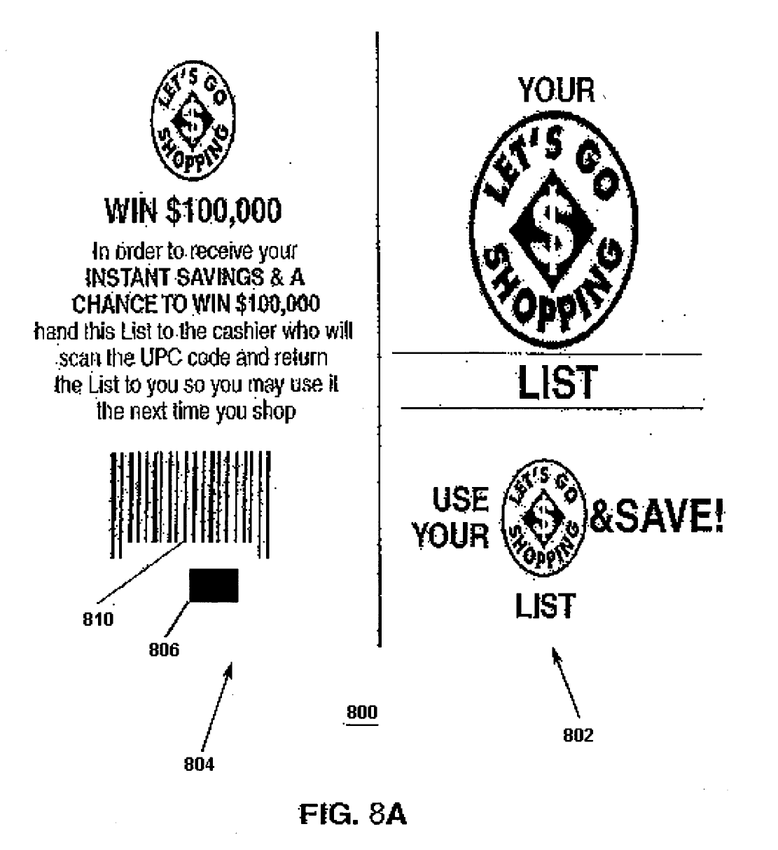

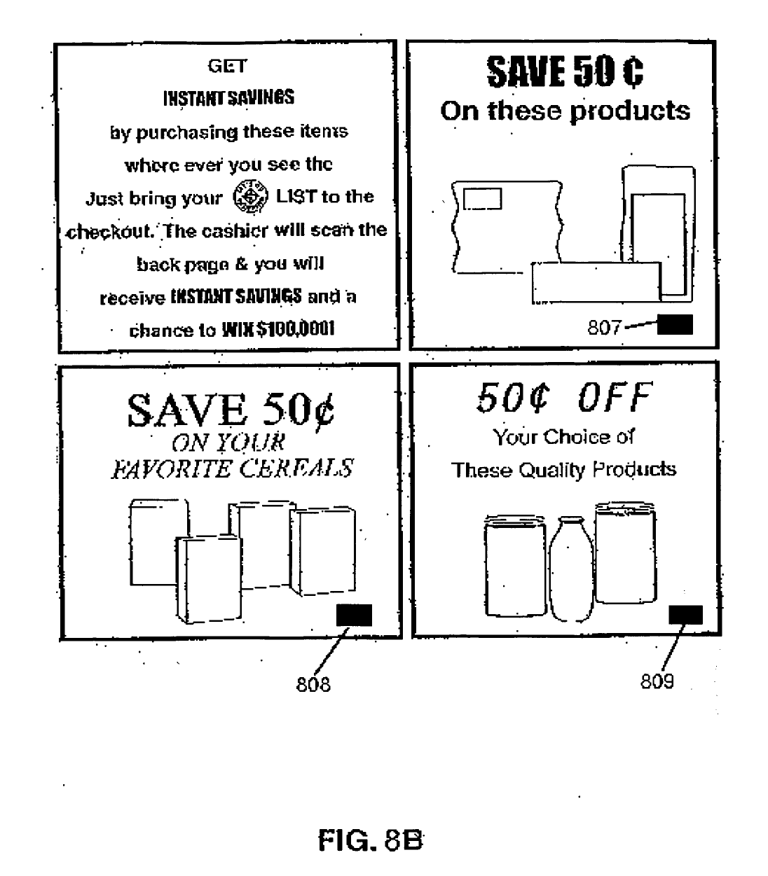

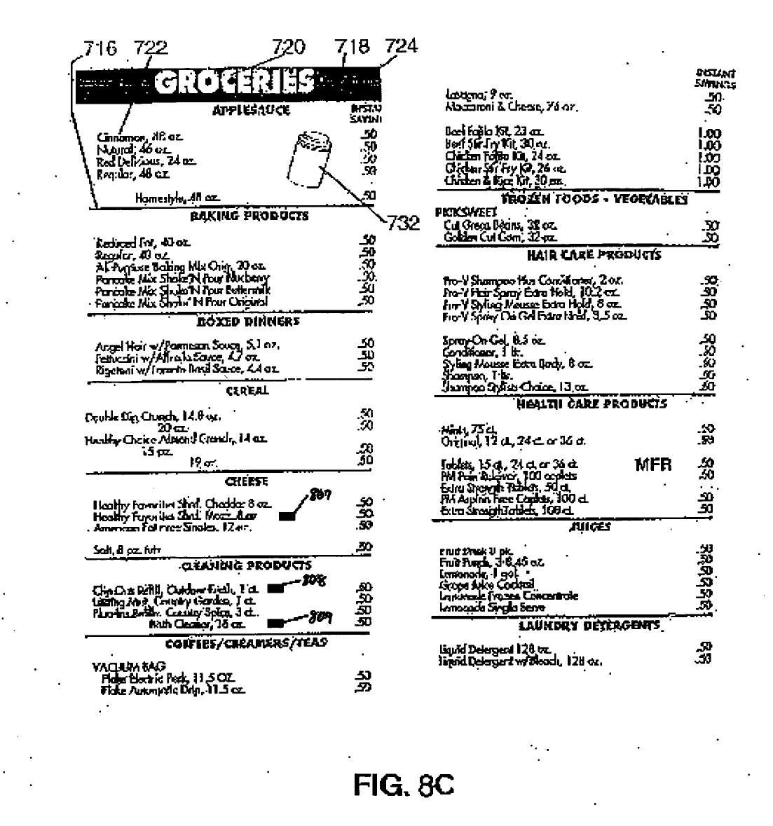

In recent years, many retail stores have moved away from having employees at checkout lanes. In their place, such retail stores have set up automatic checkout lanes where the customer may scan in their respective purchases, coupon, or entitlements. In order to take advantage of such trend, in another embodiment of the present invention, and as shown in FIGS. 8A-8B, a coupon booklet 800 may be provided. Coupon booklet 800 may include a number of device(s) 806, such as a so-called radio frequency identification device (RFID). Such device(s) may transmit and/or receive signals as hereinbelow described. As shown in FIG. 8A, the device 806 may be located on the back cover 804 of booklet 800. Alternatively, the device 806 may also be located on front cover 802 of booklet 800 or on any other page in between the front and back covers.

The transmitting device may transmit a signal containing information which relates to all of the items identified in the coupon booklet 800 and their associated discounts/entitlements. Such information may correspond to the information provided on a UPC code 810. Alternatively, the device may provide information relating to only one item or less than all of the items in the booklet 800. For example, a respective device (see 807, 808, and 809 of FIG. 8B) may be utilized for each offer of a number of items.

The booklet 800 may also include a code such as a UPC code 810. Such code 810 may be utilized when the store does not have the ability to receive transmitted information provided by the device(s) of the booklet 800.

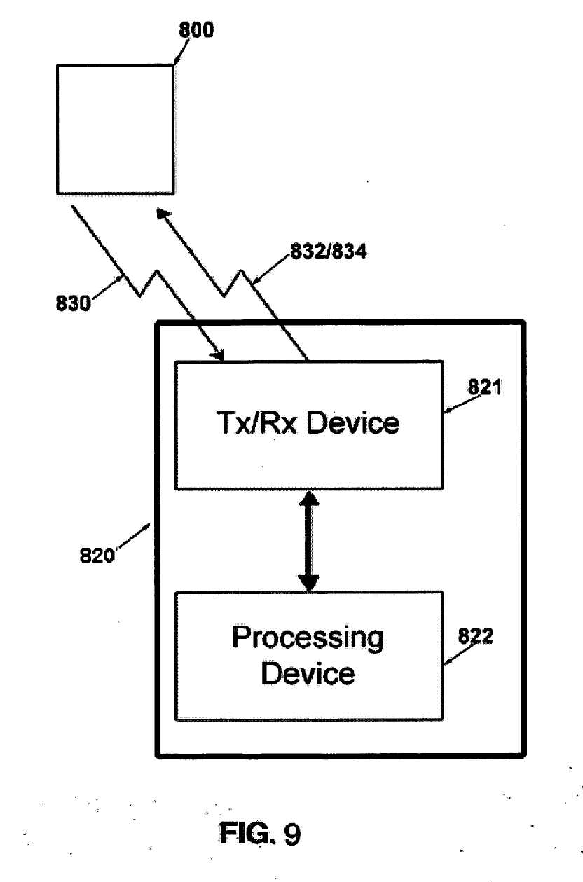

As shown in FIG. 9, a store may include a point of sale (POS) system 820 which includes a transmitting and/or receiving device 821 and a processing device 822. The device 821 is adapted to receive a transmitted signal 830 from the coupon booklet 800 of a respective customer during checkout. The received signal 830 is supplied from the device 821 to the processing device 822, wherein the information related to such signal is processed in a predetermined manner. Such processing may be similar to that previously described with reference to FIGS. 5A and 5B.

As previously mentioned, the signal 830 may represent information such as that provided on the UPC 810. In such situation, a database having the actual discounts/entitlements for each item in the booklet 800 may be stored in a memory contained in or coupled to the POS system 820. Alternatively, the signal 830 may represent information pertaining to the actual discounts/entitlements for each item or a number of such items in the booklet 800. As is to be appreciated, if information pertaining to the actual discounts/entitlements is stored within a memory device of the booklet 800, such as in a memory of the device 806 or in a memory coupled thereto, then the amount of memory space for a memory in the store or POS may be reduced.

The device(s) of the booklet 800 may continuously transmit the information signal 830. Alternatively, such device(s) may be activated at a predetermined time or upon a predetermined event, such as when a customer enters a respective store or when the customer approaches a POS. Such activation of the device(s) may be initiated by an activation signal 832 supplied from the transmitting/receiving device 821, as shown in FIG. 9. Upon receiving the activation signal 832, the device(s) begins transmission of the information signal 830. Upon leaving the POS area or upon leaving the respective store, a deactivation signal 834 may be supplied from the transmitting/receiving device 821, as shown in FIG. 9. Upon receipt of such deactivation signal 834, the device(s) may terminate transmission of the information signal 830.

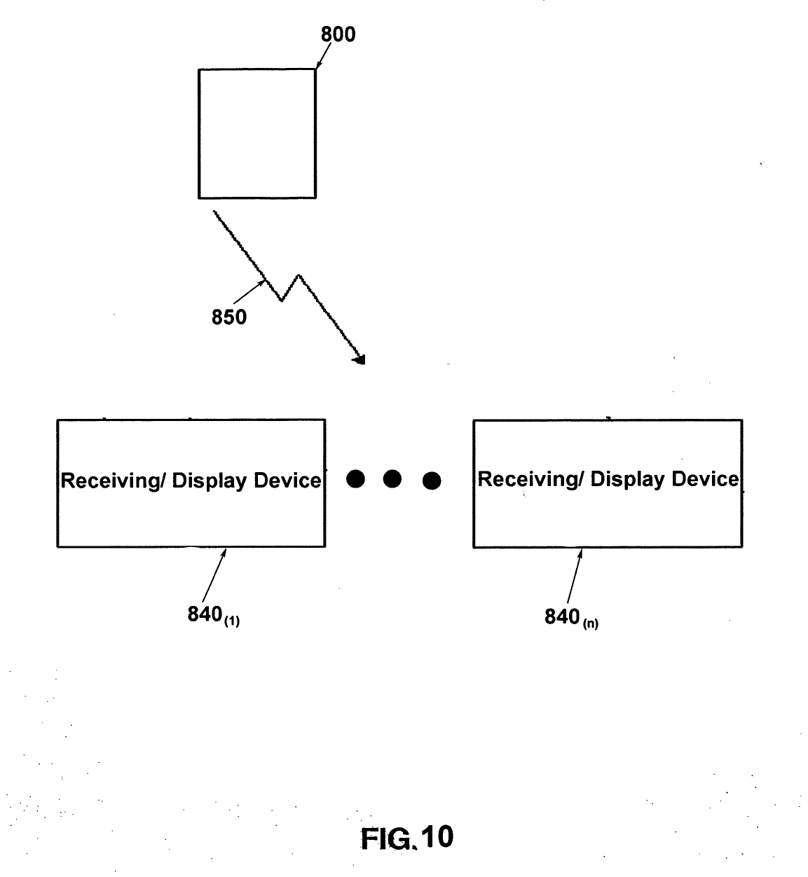

As shown in FIG. 10, a store may include a number of receiving/display device(s) 840₍₁₎ . . . 840₍ₙ₎ which may be located on a number of products or located nearby to such product(s) and which are adaptable to receive a transmitting signal from the booklet 800 when the customer is in close proximity and, in response thereto, to provide an indication to the customer of a discount/entitlement or other information. More specifically, in such situation, the device of the booklet 800 is continuously transmitting an information signal 850 as the customer walks through the respective store. When the customer is in close proximity to a respective one of the devices 840, the transmitted signal 850 is received by the respective device 840 whereupon the device 840 provides an indication such as a flashing light or electronic display highlighting a respective discount so as to inform the customer of such discount.

Further, the information transmitted from a transmitting device (such as device 806 or device 821 or other such transmitting devices) may be time sensitive. That is, these devices could be configured so as to transmit different information data at different times. For example, first information data may be transmitted from such device(s) during a first week, and second information data (which is different from the first information data) may be transmitted during the second week. Such arrangement may be useful to deal with offers that have expired or will expire.

It will be appreciated that, while the present invention was described in terms of coupon redemption, the present is not limited thereto and is applicable to other forms of redemption such as rebates or credit accounts.

Although the present invention has been described with a single bar code only for each booklet, it is within the present invention to include one or more one-dimensional or two-dimensional bar codes or a combination thereof where each bar code may represent a plurality of items in the booklet.

Although preferred embodiments of the present invention and modifications thereof have been described in detail herein, it is to be understood that this invention is not limited to those precise embodiments and modifications, and that other modifications and variations may be effected by one skilled in the art without departing from the spirit and scope of the invention as defined by the appended claims.

1. A coupon booklet for use by a customer at a number of stores, said booklet comprising:
a front cover and a back cover;
a number of pages provided between the front and back covers;
a listing of a plurality of items entitled to discounts provided on at least one of said front and back covers and said number of pages; and
a number of transmitting devices, each coupled to one of said front and back covers and said number of pages and operable to transmit an information signal relatable to said plurality of items in a wireless manner;
wherein said front and back covers and said number of pages are arranged such that said front and back cover and said number of pages are openable and closeable in a book-like manner.

2. The booklet according to claim 1, wherein said information signal includes a plurality of portions each representing information pertaining to one of said plurality of items.

3. The booklet according to claim 1, further comprising a single bar code which identifies said plurality of items.

4. The booklet according to claim 3, wherein said information signal represents information corresponding to that of said bar code.

5. The booklet according to claim 1, wherein the transmitting device is configured as an integrated circuit (IC) chip.

6. The booklet according to claim 1, wherein the transmitting device automatically transmits said information signal for a predetermined time period.

7. The booklet according to claim 1, wherein the transmitting device includes means for activating and/or de-activating the transmitting device and wherein the transmitting device transmits said information signal only after being activated and terminates transmission of said information signal after being de-activated.

8. The booklet according to claim 7, wherein the transmitting device is activated and/or de-activated only within the number of stores.

9. The booklet according to claim 8, wherein the transmitting device is automatically activated after entering any respective one of the number of stores and is automatically de-activated after checking out in the respective store.

10. A coupon booklet for use by a customer at a number of stores, said booklet comprising:
a front cover and a back cover;
a number of pages provided between the front and back covers;
a listing of a plurality of items entitled to discounts provided on at least one of said front and back covers and said number of pages; and
a plurality of transmitting devices each coupled to one of said front and back covers and said number of pages and operable to transmit an information signal relatable to only a respective one of said plurality of items in a wireless manner;
wherein said front and back covers and said number of pages are arranged such that said front and back cover and said number of pages are openable and closeable in a book-like manner.

11. The booklet according to claim 10, further comprising a single bar code which identifies said plurality of items.

12. The booklet according to claim 10, wherein each of the transmitting devices is configured as an integrated circuit (IC) chip.

13. The booklet according to claim 10, wherein each of the transmitting devices automatically transmits the respective information signal for a predetermined time period.

14. The booklet according to claim 10, wherein each of the transmitting devices includes means for activating and/or de-activating the respective transmitting device and wherein each of the transmitting devices transmits the respective information signal only after being activated and terminates transmission of the respective information signal after being de-activated.

15. The booklet according to claim 14, wherein each of the transmitting devices is activated and/or de-activated only within the number of stores.

16. The booklet according to claim 15, wherein each of the transmitting devices is automatically activated after entering any respective one of the number of stores and is automatically de-activated after checking out in the respective store.

17. The booklet according to claim 14, wherein prior to purchasing a number of desired items at one of the number of stores all of the transmitting devices are activated such that each of the transmitting devices transmits the respective information signal and after purchasing the number of desired items at the respective store the transmitting devices corresponding thereto are de-activated so as to be prohibited from being re-activated for a predetermined time.

18. The booklet according to claim 17, wherein after purchasing the number of desired items the transmitting devices corresponding to items not purchased by the customer remain activated.

19. A coupon booklet for use by a customer at a number of stores, said booklet comprising:
a front cover and a back cover;
a number of pages provided between the front and back covers;
a listing of a plurality of items entitled to discounts provided on at least one of said front and back covers and said number of pages; and
transmitting means coupled to one of said front and back covers and said number of pages for transmitting an information signal relatable to said plurality of items in a wireless manner;
wherein said front and back covers and said number of pages are arranged such that said front and back cover and said number of pages are openable and closeable in a book-like manner.

20. The booklet according to claim 19, wherein said information signal includes a plurality of portions each representing information pertaining to one of said plurality of items.

21. The booklet according to claim 19, further comprising a single bar code which identifies said plurality of items.

22. The booklet according to claim 21, wherein said information signal represents information corresponding to that of said bar code.

23. The booklet according to claim 19, wherein the transmitting means includes an integrated circuit (IC) chip.

24. The booklet according to claim 19, wherein the transmitting means automatically transmits said information signal for a predetermined time period.

25. The booklet according to claim 19, wherein the transmitting means transmits said information signal only after being activated and terminates transmission of said information signal after being de-activated.

26. The booklet according to claim 25, wherein the transmitting means is activated and/or de-activated only within the number of stores.

27. The booklet according to claim 26, wherein the transmitting means is automatically activated after entering any respective one of the number of stores and is automatically de-activated after checking out in the respective store.

28. A coupon booklet for use by a customer at a number of stores, said booklet comprising:
a front cover and a back cover;
a number of pages provided between the front and back covers;
a listing of a plurality of items entitled to discounts provided on at least one of said front and back covers and said number of pages; and
a plurality of transmitting means each coupled to one of said front and back covers and said number of pages for transmitting an information signal relatable to only a respective one of said plurality of items in a wireless manner;
wherein said front and back covers and said number of pages are arranged such that said front and back cover and said number of pages are openable and closeable in a book-like manner.

29. The booklet according to claim 28, further comprising a single bar code which identifies said plurality of items.

30. The booklet according to claim 28, wherein each of the transmitting means includes an integrated circuit (IC) chip.

31. The booklet according to claim 28, wherein each of the transmitting means automatically transmits the respective information signal for a predetermined time period.

32. The booklet according to claim 28, wherein each of the transmitting means includes means for activating and/or de-activating the respective transmitting means and wherein each of the transmitting means transmits the respective information signal only after being activated and terminates transmission of the respective information signal after being de-activated.

33. The booklet according to claim 32, wherein each of the transmitting means is activated and/or de-activated only within the number of stores.

34. The booklet according to claim 33, wherein each of the transmitting means is automatically activated after entering any respective one of the number of stores and is automatically de-activated after checking out in the respective store.

35. The booklet according to claim 32, wherein prior to purchasing a number of desired items at one of the number of stores all of the transmitting means are activated such that each of the transmitting means transmits the respective information signal and after purchasing the number of desired items at the respective store the transmitting means corresponding thereto are de-activated so as to be prohibited from being re-activated for a predetermined time.

36. The booklet according to claim 35, wherein after purchasing the number of desired items the transmitting means corresponding to items not purchased by the customer remain activated.

37. The booklet according to claim 1, further comprising a table of contents which identifies types of items set forth in said listing.

38. The booklet according to claim 1, wherein said listing is arranged in index form.

39. The booklet according to claim 1, wherein said booklet is rectangular in shape.

40. The booklet according to claim 39, wherein said booklet has dimensions of approximately 3.5 inches by 6 inches.

41. The booklet according to claim 3, wherein said single bar code is a single universal product code and wherein said single universal product code is formed on said back cover.

42. The booklet according to claim 1, wherein a date indicating a time period in which said booklet is effective is on said front cover.

43. The booklet according to claim 1, further comprising tab means formed along an edge of said booklet for extending said booklet in a particular direction.

44. The booklet according to claim 38, wherein said index form includes having said plurality of items arranged alphabetically.

45. The booklet according to claim 38, wherein said index form includes having said plurality of items arranged according to food or product groups.

46. The booklet according to claim 38, wherein said index form includes having said plurality of items arranged according to price.

47. The booklet according to claim 38, wherein said index form includes having said plurality of items arranged according to manufacturers.

48. The booklet according to claim 38, wherein said listing arranged in said index form indicates a credit for each item which is receivable upon purchase thereof and wherein said credit is applicable to a future transaction unrelated to a present transaction.

49. The booklet according to claim 38, wherein said index form is color-coded.

50. The booklet according to claim 38, wherein said index form is color-coded in accordance with a type of said plurality of items.

51. The booklet according to claim 38, wherein the index form is color-coded according to a food or product group of said plurality of items.

52. The booklet according to claim 38, wherein said index form includes at least one miniature picture of a respective item entitled to a discount which is positioned proximate the listing of said respective item.

53. The booklet according to claim 38, wherein sub-headings of said index form are segregated by lateral dividing lines.

54. The booklet according to claim 38, wherein said index form is arranged by type at a top edge of each page.

55. The booklet according to claim 38, further comprising a number of advertisements in coupon form emphasizing a particular item or items entitled to the discount or discounts indicated in said listing arranged in said index form.

56. The booklet according to claim 45, wherein an indicator of a respective group is provided adjacent to the respective group.

57. The booklet according to claim 45, wherein each group includes sub-headings arranged according to a brand of a respective item or items.

58. The booklet according to claim 57, wherein said sub-headings of each brand is further sub-divided by item.

59. The booklet according to claim 48, wherein said credit is applied to any of a number of accounts of said customer.

60. The booklet according to claim 59, wherein one of said accounts is one of a holiday savings account, a vacation savings account, a tuition savings account, and an interest-bearing account.

61. The booklet according to claim 54, wherein said type includes at least one of groceries, appliances, cameras, film and cookware.

62. The booklet according to claim 54, wherein the types are color-coded.

63. The booklet according to claim 1, further comprising areas for advertisements.

64. A coupon booklet usable at a number of stores, said booklet comprising:
a front cover, a back cover and a number of pages in between said front cover and said back cover which are arranged in a book-like manner such that said front and back covers and said number of pages are openable and closeable in a book-like manner;
a listing of two or more items and entitlements associated therewith; and
a transmitting device coupled to one of said front and back covers and said number of pages and operable to transmit an information signal relatable to said items in a wireless manner.

65. A coupon system for use in a store, said system comprising:
coupon booklet having a front cover and a back cover, a number of pages provided between the front and back covers, a listing of a plurality of items entitled to discounts provided on at least one of said front and back covers and said number of pages, and a transmitting device coupled to one of said front and back covers and said number of pages and operable to transmit signals;
receiving means for receiving the transmitted signals from said transmitting device; and
means for providing an indication of information to a customer when the receiving means receives the transmitted signals.
